(19) United States
(12) Patent Application Publication
(10) Pub. No.: US 2025/0139517 A1
(43) Pub. Date: May 1, 2025

(54) LOSS REPORTING FOR DISTRIBUTED TRAINING OF A MACHINE LEARNING MODEL

(71) Applicant: QUALCOMM Incorporated, San Diego, CA (US)

(72) Inventors: Yuwei REN, Beijing (CN); Chenxi HAO, Beijing (CN); Taesang YOO, San Diego, CA (US); Hao XU, Beijing (CN); Yu ZHANG, San Diego, CA (US); Rui HU, Beijing (CN); Ruiming ZHENG, Beijing (CN); Liangming WU, Beijing (CN); Yin HUANG, Beijing (CN)

(21) Appl. No.: 18/835,792

(22) PCT Filed: Apr. 11, 2022
(86) PCT No.: PCT/CN2022/086061

§ 371 Date: Aug. 5, 2024

(51) Int. Cl. G06N 20/00

(52) U.S. Cl. CPC G06N 20/00

(57) ABSTRACT

Various aspects of the present disclosure generally relate to wireless communication. In some aspects, a user equipment (UE) may receive information to update a machine learning model associated with a training iteration of the machine learning model. The UE may transmit a local loss value based at least in part on the training iteration of the machine learning model within a time window to report the local loss value for the training iteration, the time window having an ending. Numerous other aspects are described.

### INTRODUCTION

Aspects of the present disclosure generally relate to wireless communication and to techniques and apparatuses for machine learning model training.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving information to update a machine learning model associated with a training iteration of the machine learning model. The method may include transmitting a local loss value based at least in part on the training iteration of the machine learning model within a time window to report the local loss value for the training iteration, the time window having an ending.

Some aspects described herein relate to a method of wireless communication performed by an apparatus of a network entity. The method may include transmitting information to update a machine learning model associated with a training iteration of the machine learning model. The method may include receiving, for at least one UE, a local loss value based at least in part on the training iteration of the machine learning model within a time window to receive the local loss value for the training iteration, the time window having an ending.

Some aspects described herein relate to a method of wireless communication performed by an apparatus of a UE. The method may include receiving information to update a machine learning model associated with a training iteration of the machine learning model. The method may include transmitting a local loss value based at least in part on the training iteration of the machine learning model and information indicating a batch size of data to be used for one or more training iterations of the machine learning model.

Some aspects described herein relate to a method of wireless communication performed by a network entity. The method may include transmitting information to update a machine learning model associated with a training iteration of the machine learning model. The method may include receiving, for at least one UE, a local loss value based at least in part on the training iteration of the machine learning model and information indicating a batch size of data to be used for one or more training iterations of the machine learning model.

Some aspects described herein relate to an apparatus for wireless communication at a UE. The apparatus may include a memory and one or more processors coupled to the memory. The one or more processors may be configured to receive information to update a machine learning model associated with a training iteration of the machine learning model. The one or more processors may be configured to transmit a local loss value based at least in part on the training iteration of the machine learning model within a time window to report the local loss value for the training iteration, the time window having an ending.

Some aspects described herein relate to an apparatus for wireless communication at a network entity. The apparatus may include a memory and one or more processors coupled to the memory. The one or more processors may be configured to transmit information to update a machine learning model associated with a training iteration of the machine learning model. The one or more processors may be configured to receive, for at least one UE, a local loss value based at least in part on the training iteration of the machine learning model within a time window to receive of the local loss value for the training iteration, the time window having an ending.

Some aspects described herein relate to an apparatus for wireless communication at a UE. The apparatus may include a memory and one or more processors coupled to the memory. The one or more processors may be configured to receive information to update a machine learning model associated with a training iteration of the machine learning model. The one or more processors may be configured to transmit a local loss value based at least in part on the training iteration of the machine learning model and information indicating a batch size of data to be used for one or more training iterations of the machine learning model.

Some aspects described herein relate to an apparatus for wireless communication at a network entity. The apparatus may include a memory and one or more processors coupled to the memory. The one or more processors may be configured to transmit information to update a machine learning model associated with a training iteration of the machine learning model. The one or more processors may be configured to receive, for at least one UE, a local loss value based at least in part on the training iteration of the machine learning model and information indicating a batch size of data to be used for one or more training iterations of the machine learning model.

Some aspects described herein relate to a non-transitory computer-readable medium that stores a set of instructions for wireless communication by a UE. The set of instructions, when executed by one or more processors of the UE, may cause the UE to receive information to update a machine learning model associated with a training iteration of the machine learning model. The set of instructions, when executed by one or more processors of the UE, may cause the UE to transmit a local loss value based at least in part on the training iteration of the machine learning model within a time window to report the local loss value for the training iteration, the time window having an ending.

Some aspects described herein relate to a non-transitory computer-readable medium that stores a set of instructions for wireless communication by a network entity. The set of instructions, when executed by one or more processors of the network entity, may cause the network entity to transmit information to update a machine learning model associated with a training iteration of the machine learning model. The set of instructions, when executed by one or more processors of the network entity, may cause the network entity to receive, for at least one UE, a local loss value based at least in part on the training iteration of the machine learning model within a time window to receive the local loss value for the training iteration, the time window having an ending.

Some aspects described herein relate to a non-transitory computer-readable medium that stores a set of instructions for wireless communication by a UE. The set of instructions, when executed by one or more processors of the UE, may cause the UE to receive information to update a machine learning model associated with a training iteration of the machine learning model. The set of instructions, when executed by one or more processors of the UE to transmit a local loss value based at least in part on the training iteration of the machine learning model and information indicating a batch size of data to be used for one or more training iterations of the machine learning model.

Some aspects described herein relate to a non-transitory computer-readable medium that stores a set of instructions for wireless communication by a network entity. The set of instructions, when executed by one or more processors of the network entity, may cause the network entity to transmit information to update a machine learning model associated with a training iteration of the machine learning model. The set of instructions, when executed by one or more processors of the network entity, may cause the network entity to receive, for at least one UE, a local loss value based at least in part on the training iteration of the machine learning model and information indicating a batch size of data to be used for one or more training iterations of the machine learning model.

Some aspects described herein relate to an apparatus for wireless communication. The apparatus may include means for receiving information to update a machine learning model associated with a training iteration of the machine learning model. The apparatus may include means for transmitting a local loss value based at least in part on the training iteration of the machine learning model within a time window to report the local loss value for the training iteration, the time window having an ending.

Some aspects described herein relate to an apparatus for wireless communication. The apparatus may include means for transmitting information to update a machine learning model associated with a training iteration of the machine learning model. The apparatus may include means for receiving, for at least one UE, a local loss value based at least in part on the training iteration of the machine learning model within a time window to receive the local loss value for the training iteration, the time window having an ending.

Some aspects described herein relate to an apparatus for wireless communication. The apparatus may include means for receiving information to update a machine learning model associated with a training iteration of the machine learning model. The apparatus may include means for transmitting a local loss value based at least in part on the training iteration of the machine learning model and information indicating a batch size of data to be used for one or more training iterations of the machine learning model.

Some aspects described herein relate to an apparatus for wireless communication. The apparatus may include means for transmitting information to update a machine learning model associated with a training iteration of the machine learning model. The apparatus may include means for receiving, for at least one UE, a local loss value based at least in part on the training iteration of the machine learning model and information indicating a batch size of data to be used for one or more training iterations of the machine learning model.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4A is a diagram illustrating an example of a machine learning model and training of the machine learning model, in accordance with the present disclosure.

FIG. 4B is a diagram illustrating an example of channel state information compression and decompression, in accordance with the present disclosure.

FIGS. 5A-5B are diagrams illustrating examples of multi-node cooperation for distributed training, in accordance with the present disclosure.

FIG. 6 is a diagram illustrating an example of multi-node cooperation for distributed training, in accordance with the present disclosure.

FIG. 7 is a diagram illustrating an example associated with loss reporting for distributed training of a machine learning model, in accordance with the present disclosure.

FIGS. 8A-8B are diagrams illustrating an example associated with loss reporting for distributed training of a machine learning model, in accordance with the present disclosure.

FIG. 9 is a diagram illustrating an example associated with loss reporting for distributed training of a machine learning model, in accordance with the present disclosure.

FIGS. 10A-10B are diagrams illustrating examples associated with loss reporting for distributed training of a machine learning model, in accordance with the present disclosure.

FIGS. 11A-11C are diagrams illustrating examples associated with loss reporting for distributed training of a machine learning model, in accordance with the present disclosure.

FIGS. 12-15 are diagrams illustrating example processes associated with loss reporting for distributed training of a machine learning model, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example implementation of code and circuitry for an apparatus, in accordance with the present disclosure.

FIG. 19 is a diagram of an example apparatus for wireless communication, in accordance with the present disclosure.

FIG. 20 is a diagram illustrating an example of a hardware implementation for an apparatus employing a processing system, in accordance with the present disclosure.

FIG. 21 is a diagram illustrating an example implementation of code and circuitry for an apparatus, in accordance with the present disclosure.

### DETAILED DESCRIPTION

Machine learning is an artificial intelligence approach. In machine learning, a device may utilize models to analyze large sets of data, recognize patterns in the data, and make a prediction with respect to new data. In one example, a machine learning model may be used by a transmitting device (e.g., a user equipment (UE)) to encode channel state information (CSI) into a more compact representation of the CSI. A receiving device (e.g., a network entity) may receive the encoded CSI, and use a machine learning model to decode the encoded CSI and obtain the original CSI. CSI may refer to information that indicates channel properties of a communication link, and may include a channel quality indicator (CQI), a precoding matrix indicator (PMI), a rank indicator (RI), or the like.

Training of a machine learning model may enable the machine learning model to learn weights that are to be applied to a set of variables to determine a result. Continuous training of a machine learning model may be used to maintain the accuracy of the machine learning model over time and to facilitate the extension of the machine learning model to new types of data. Continuous training may include retraining of a machine learning model one or more times to prevent the machine learning model from becoming unreliable or inaccurate. In continuous training, a machine learning model may be trained to minimize a value of a loss function (a “loss function” measures how well a machine learning model's algorithm models a dataset, for example, based on a degree by which an output of the machine learning model deviates from an actual result). According to a training procedure, a forward computation (a “forward computation” or “forward propagation” may refer to computation that is performed from an input layer, through one or more hidden layers, to an output layer of a machine learning model to generate an output of the machine learning model) using the machine learning model may be performed, and the loss function may be applied to the forward computation to determine a loss value (a “loss value” may refer to a value (e.g., a numeric value) of a loss function applied to a forward computation of a machine learning model, and may indicate a degree by which an output of the machine learning model deviates from an actual result). According to the training procedure, using the loss value, backpropagation of the machine learning model may be performed to determine adjustments to the weights of the machine learning model (“backpropagation” includes traversing a machine learning model backwards, from an output layer through one or more hidden layers, using an algorithm for tuning weights of the machine learning model based on the loss value). According to the training procedure, the machine learning model may be updated using the adjustments to the weights. Several iterations of the training procedure may be performed to minimize the value of the loss function. In the example of CSI encoding (at a transmitting device)/decoding (at a receiving device), continuous training of a machine learning model may facilitate adaptation of the machine learning model to different channel variations after deployment of the machine learning model.

In some examples, training (e.g., continuous training, as described above) of a machine learning model may use multi-node cooperation. Multi-node cooperation may use distributed training, in which the training load for a machine learning model is distributed across multiple nodes (e.g., multiple UEs). The multiple nodes may each store a copy of the machine learning model, and the distributed training may result in an update to the machine learning model that is the same across all of the nodes (e.g., to result in each of the multiple nodes storing the same updated copy of the machine learning model). One technique for distributed training includes loss reporting. Here, each node involved in distributed training may determine a loss value associated with a forward computation of a machine learning model using local data, and report the loss value to a central node (e.g., a node that manages distributed training, such as a central unit or a device of a core network). The central node may aggregate the received local loss values from the nodes, determine an update to the machine learning model using an aggregated loss value, and transmit information for updating the machine learning model to the nodes (e.g., each of the nodes receives the same information for updating the machine learning model). Each node may then update the machine learning model (e.g., the node's local copy of the machine learning model) using the information, determine a new loss value, and the procedure of loss reporting, loss value aggregation, and model updating is repeated for multiple training iterations (a “training iteration” or “epoch” may refer to one cycle of a machine learning model training procedure in which a forward computation of the machine learning model is performed, a loss value based at least in part on the forward computation is calculated, backpropagation of the machine learning model is performed using the loss value, and weights of the machine learning model are updated based at least in part on the backpropagation, where the cycle may begin at any one of the aforementioned steps of the training procedure). As each node involved in distributed training reports a local loss value in each training iteration for the machine learning model, a speed of the distributed training is constrained by a slowest node to report a local loss value. Consequently, nodes having the capability to compute loss values relatively faster may experience downtime while waiting for slower nodes to complete loss value computations.

In some techniques and apparatuses described herein, a UE involved in distributed training of a machine learning model may receive information, to update the machine learning model, associated with a training iteration of the machine learning model, and the UE may transmit a local loss value, for the training iteration of the machine learning model, in a time window for reporting the local loss value for the training iteration. The time window may have a start, and an ending after which the local loss value for the training iteration is not to be reported. In some aspects, the time window may end prior to expiration of a timer that runs from a beginning of a period of time in which the machine learning model is updated for the training iteration. In some aspects, the time window may be an occasion of a periodic resource for loss reporting (e.g., the time window corresponds to a time resource of the occasion of the periodic resource). A “periodic resource” may refer to a time resource that occurs periodically (e.g., at regular time intervals), and an “occasion” of the periodic resource may refer to a single instance of the time resource. In some aspects, the time window may start after a time gap from an end of the UE's reception of information for updating the machine learning model for the training iteration.

Accordingly, if the UE is unable to report a local loss value (e.g., because computation of the local loss value is not complete) by the ending of the time window, then the UE may refrain from reporting the local loss value for the training iteration. In this way, the distributed training is not constrained by UEs that are relatively slow to provide loss value reporting, and the distributed training may be completed with improved speed, reduced downtime, and with efficient utilization of UE processing resources. Moreover, the techniques and apparatuses described herein conserve UE processing resources and power resources involved in training a machine learning model, as the ending of the time window for loss reporting provides a cutoff of lengthy local loss value computations that otherwise may continue unconstrained.

In some aspects, the UE may receive a configuration for a batch size of data to be used for one or more training iterations of the machine learning model (a “batch size” may refer to a quantity of training samples that are to be used in one training iteration for training a machine learning model). Responsive to the batch size being greater than a size of local data at the UE, the UE may refrain from reporting the local loss value. Responsive to the batch size being less than a size of local data at the UE, the UE may select a set of data samples (e.g., equivalent to the configured batch size) for the training iteration. In some aspects, the UE may indicate a size of local data at the UE (e.g., indicating a batch size that is to be used by the UE) that is applicable to each training iteration, and the UE may refrain from providing further reporting relating to batch size. In some aspects, the UE may report the local loss value and information indicating a batch size that is was used by the UE, together (e.g., in one transmission), for each training iteration. Information relating to the batch size may facilitate computation of an aggregated local loss among UEs involved in the distributed training of the machine learning model.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

In some aspects, the term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

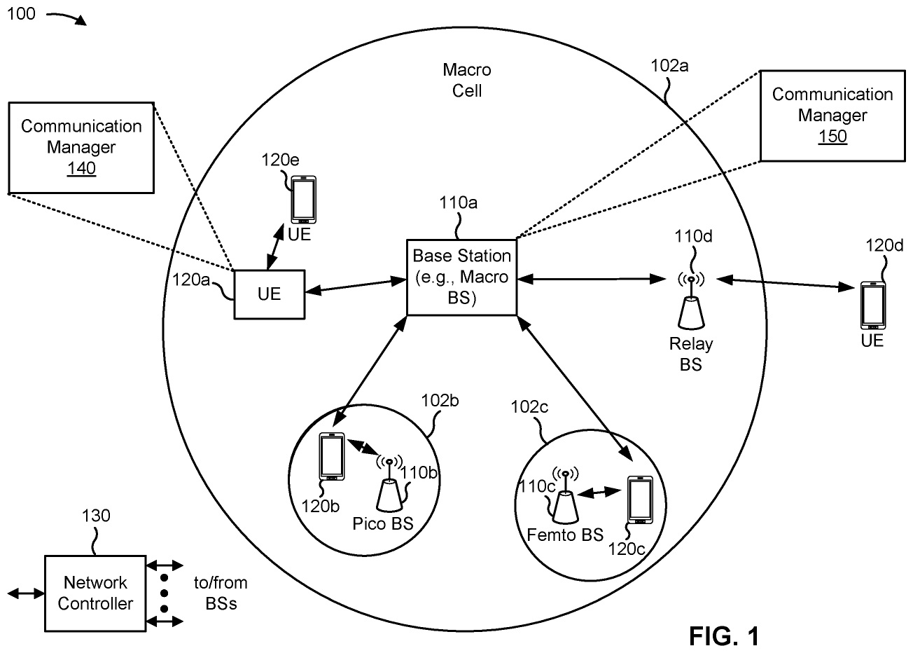

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information to update a machine learning model associated with a training iteration of the machine learning model; and transmit a local loss value based at least in part on the training iteration of the machine learning model within a time window to report the local loss value for the training iteration, the time window having an ending. As described in more detail elsewhere herein, the communication manager 140 may receive information to update a machine learning model associated with a training iteration of the machine learning model; and transmit a local loss value based at least in part on the training iteration of the machine learning model and information indicating a batch size of data to be used for one or more training iterations of the machine learning model. Additionally, or alternatively, the communication manager 140 may perform one or more other operations described herein.

In some aspects, a network entity (e.g., a base station 110) may include a communication manager 150. As described in more detail elsewhere herein, the communication manager 150 may transmit information to update a machine learning model associated with a training iteration of the machine learning model; and receive, for at least one UE, a local loss value based at least in part on the training iteration of the machine learning model within a time window to receive the local loss value for the training iteration, the time window having an ending. As described in more detail elsewhere herein, the communication manager 150 may transmit information to update a machine learning model associated with a training iteration of the machine learning model; and receive, for at least one UE, a local loss value based at least in part on the training iteration of the machine learning model and information indicating a batch size of data to be used for one or more training iterations of the machine learning model. Additionally, or alternatively, the communication manager 150 may perform one or more other operations described herein.

As indicated above, FIG. 1 is provided as an example. Other examples may differ from what is described with regard to FIG. 1.

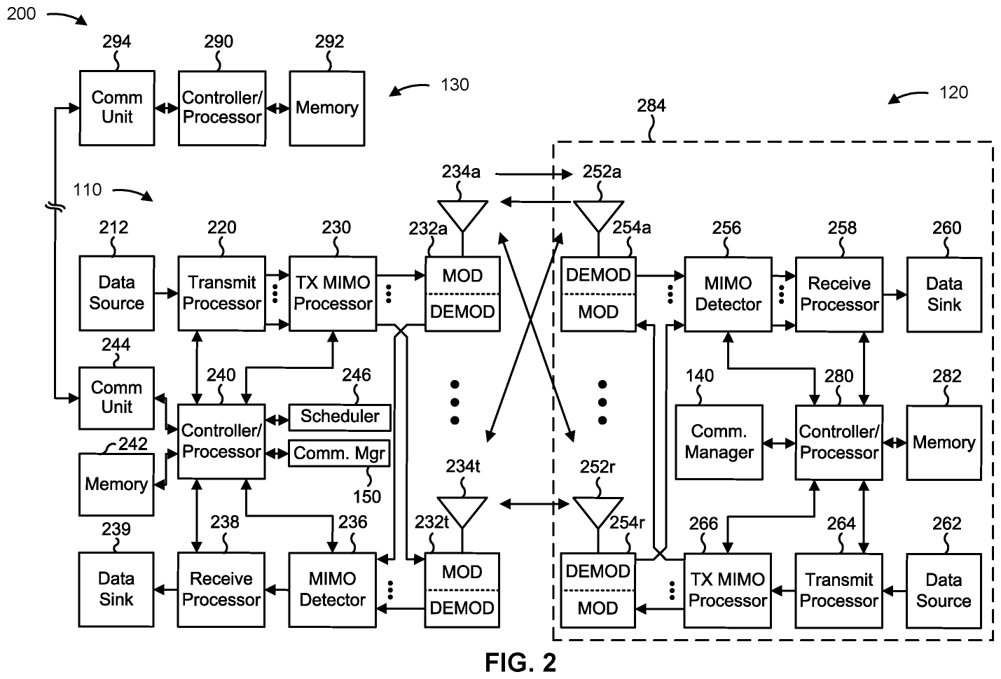

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive (RX) processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

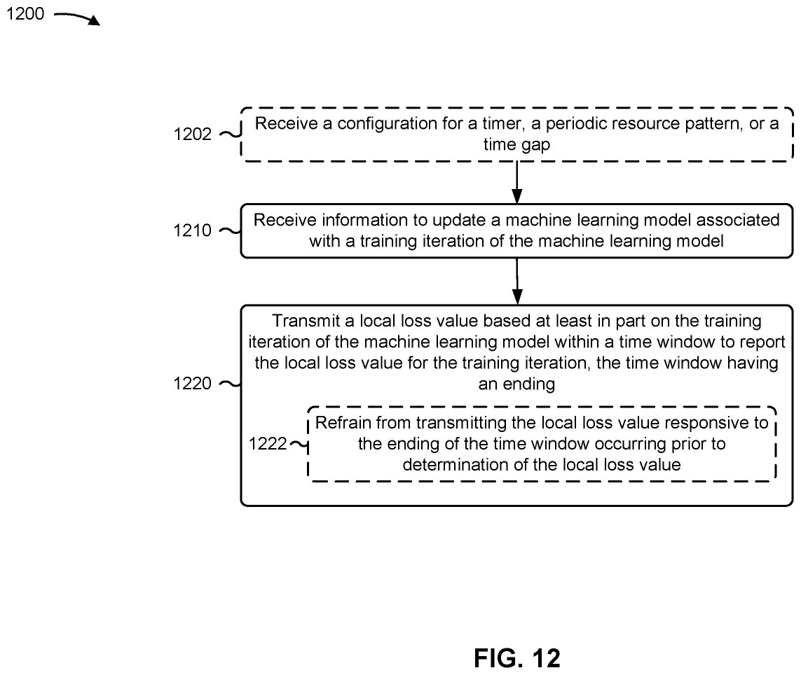

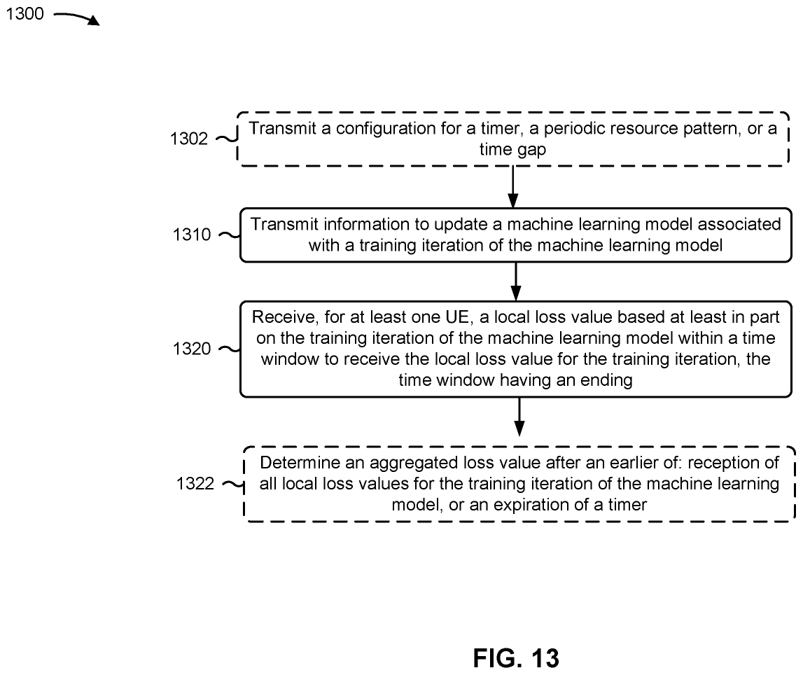

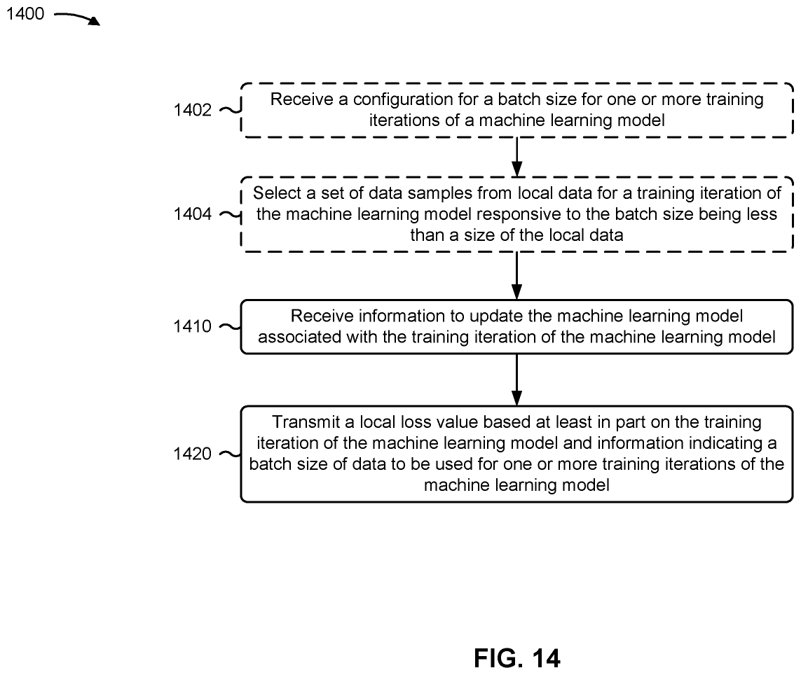

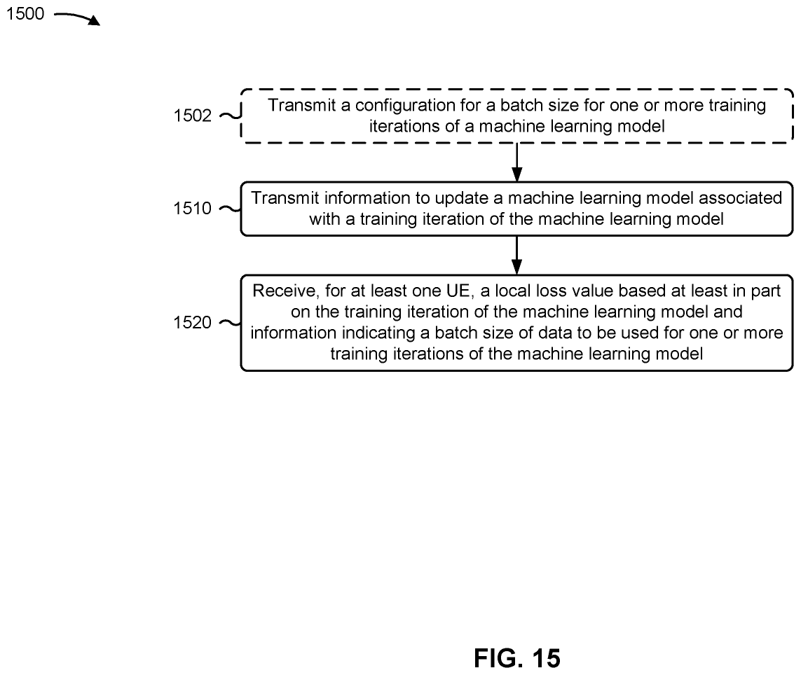

The controller/processor 240 of the base station 110, the controller/processor 280 of the UE 120, and/or any other component(s) of FIG. 2 may perform one or more techniques associated with loss reporting for distributed training of a machine learning model, as described in more detail elsewhere herein. In some aspects, a network entity described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 1200 of FIG. 12, process 1300 of FIG. 13, process 1400 of FIG. 14, or process 1500 of FIG. 15, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, process 1400 of FIG. 14, or process 1500 of FIG. 15, and/or other processes as described herein. In some examples, executing instructions may include running the instructions, converting the instructions, compiling the instructions, and/or interpreting the instructions, among other examples.

In some aspects, the UE 120 includes means for receiving information to update a machine learning model associated with a training iteration of the machine learning model; and/or means for transmitting a local loss value based at least in part on the training iteration of the machine learning model within a time window to report the local loss value for the training iteration, the time window having an ending. In some aspects, the UE 120 includes means for receiving information to update a machine learning model associated with a training iteration of the machine learning model; and/or means for transmitting a local loss value based at least in part on the training iteration of the machine learning model and information indicating a batch size of data to be used for one or more training iterations of the machine learning model. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a base station 110) includes means for transmitting information to update a machine learning model associated with a training iteration of the machine learning model; and/or means for receiving, for at least one UE, a local loss value based at least in part on the training iteration of the machine learning model within a time window to receive the local loss value for the training iteration, the time window having an ending. In some aspects, the network entity includes means for transmitting information to update a machine learning model associated with a training iteration of the machine learning model; and/or means for receiving, for at least one UE, a local loss value based at least in part on the training iteration of the machine learning model and information indicating a batch size of data to be used for one or more training iterations of the machine learning model. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR BS, 5G NB, access point (AP), a TRP, or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

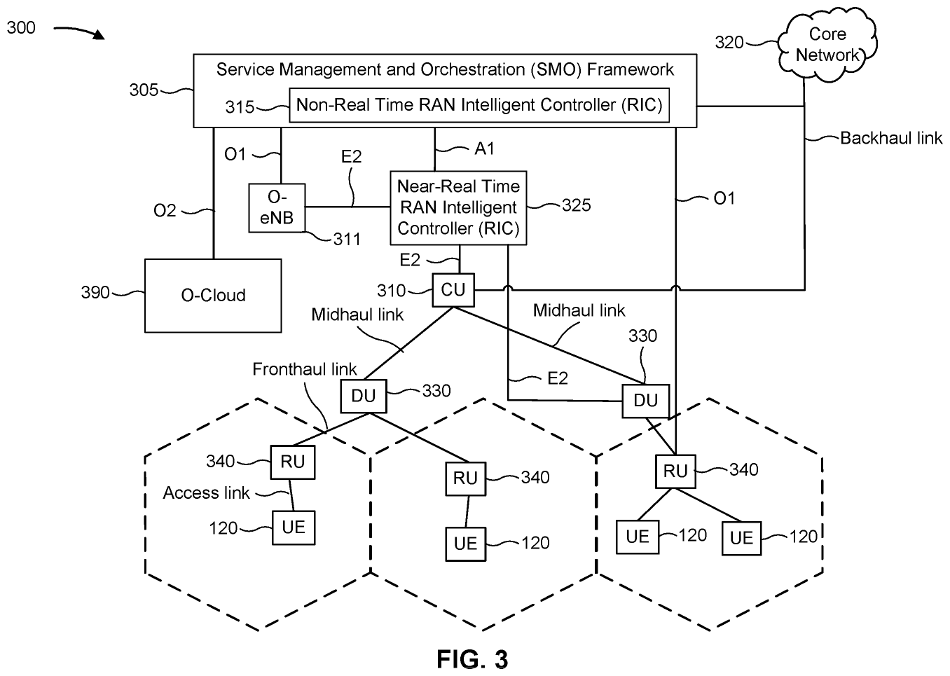

FIG. 3 is a diagram illustrating an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

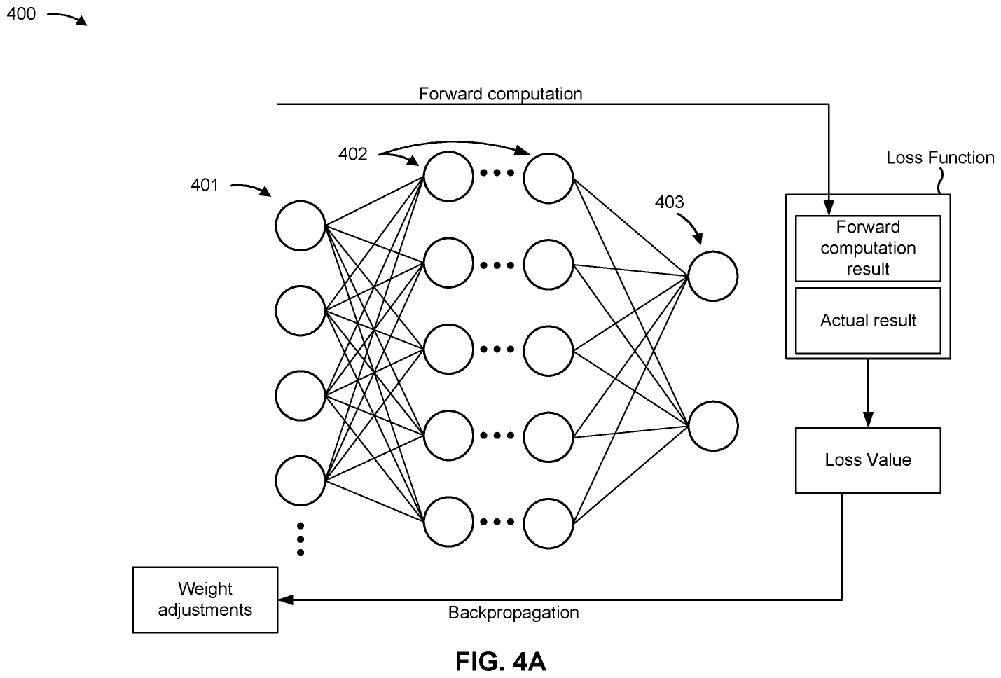

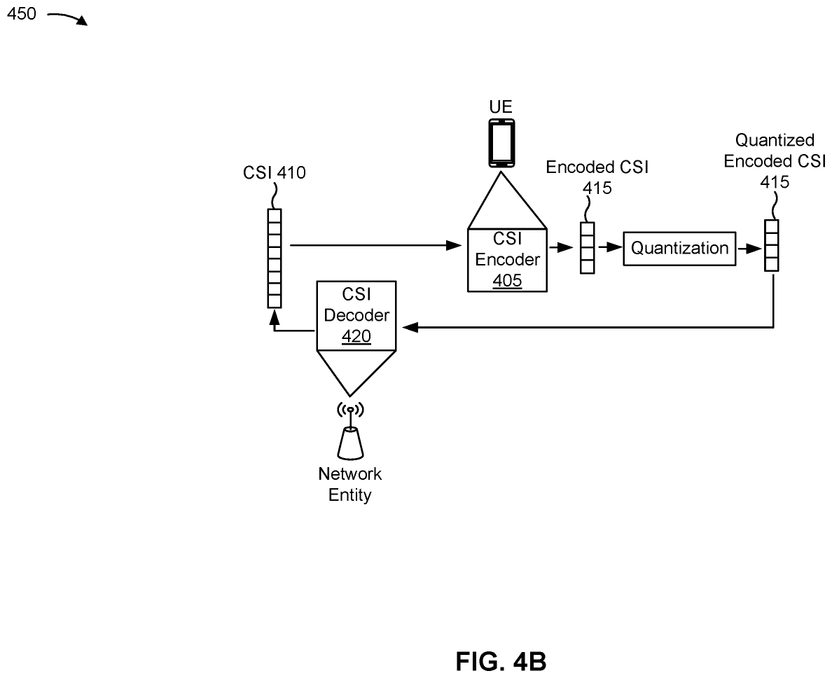

FIG. 4A is a diagram illustrating an example 400 of a machine learning model and training of the machine learning model, in accordance with the present disclosure.

Machine learning is an artificial intelligence approach with an emphasis on learning rather than computer programming. In machine learning, a device may utilize complex models to analyze a massive amount of data, recognize patterns among the data, and make a prediction without requiring a person to program specific instructions. Deep learning is a subset of machine learning, and may use massive amounts of data and computing power to simulate deep neural networks. Essentially, these networks classify datasets and find correlations between the datasets. Deep learning can acquire newfound knowledge (without human intervention), and can apply such knowledge to other datasets.

The machine learning model of FIG. 4A is shown as a neural network (a “neural network” or “artificial neural network” is a computational model that includes one or more layers of interconnected nodes that receive inputs, transform the inputs, and provide the transformed inputs as outputs). In particular, the neural network includes an interconnected group of nodes (shown as circles) in multiple layers, where nodes receive inputs and provide outputs. The neural network may include an input layer 401, one or more hidden layers 402, and an output layer 403. The neural network may receive data as an input to the input layer 401, use the one or more hidden layers to process the data, and provide an output, that is based on processing the data, at the output layer 403.

Continuous training (also referred to as continual learning or life-long learning) of the machine learning model may provide robust performance to match variations in data. In particular, continuous training (e.g., fine-tuning) may facilitate adaptation of the machine learning model to variations in environments (e.g., different channel variations) after deployment of the machine learning model. In this way, the machine learning model may maintain acceptable performance across various environments. Continuous training includes retraining of the machine learning model one or more times to prevent the machine learning model from becoming unreliable or inaccurate. For example, in continuous training, a device (e.g., a UE) may train the machine learning model to minimize a value of a loss function. According to a training procedure, the device may perform a forward computation using the machine learning model, and apply the loss function to the forward computation, along with an actual result, to determine the loss value. According to the training procedure, using the loss value, the device may perform backpropagation of the machine learning model to determine adjustments to the weights of the machine learning model. According to the training procedure, the device may update the machine learning model using the adjustments to the weights. One cycle of the training procedure is one training iteration of the machine learning mode. The device may perform several iterations of the training procedure to minimize the value of the loss function.

As indicated above, FIG. 4A is provided as an example. Other examples may differ from what is described with respect to FIG. 4A.

FIG. 4B is a diagram illustrating an example 450 of channel state information (CSI) compression and decompression, in accordance with the present disclosure.

Machine learning, such as training a neural network model, may be used to better encode CSI to achieve lower CSI feedback overhead, higher CSI accuracy, and/or better adaptability to different antenna structures and radio frequency environments. Once encoded, the original CSI may be reconstructed by using a neural network that is trained to convert the encoded CSI into the original CSI.

As shown in FIG. 4B, a UE may use a trained machine learning model for a CSI encoder 405 to encode CSI 410 (e.g., channel state feedback) into a more compact representation of the CSI (e.g., CSI compression) that is accurate. The UE may report the compressed CSI 415 (e.g., following quantization (mapping input values from a large set to output values in a smaller set) of the compressed CSI 415) to a network entity using fewer bits than would be used to report CSI that is not compressed. As further shown in FIG. 4B, the network entity may use a trained machine learning model for a CSI decoder 420 to recover the original CSI 410 from the compressed CSI 415. The machine learning model for the CSI encoder 405 and/or the CSI decoder 420 may be adaptable to various scenarios (e.g., various antenna structures, radio frequency environments, or the like) experienced by different UEs (e.g., using continuous training).

As indicated above, FIG. 4B is provided as an example. Other examples may differ from what is described with respect to FIG. 4B.

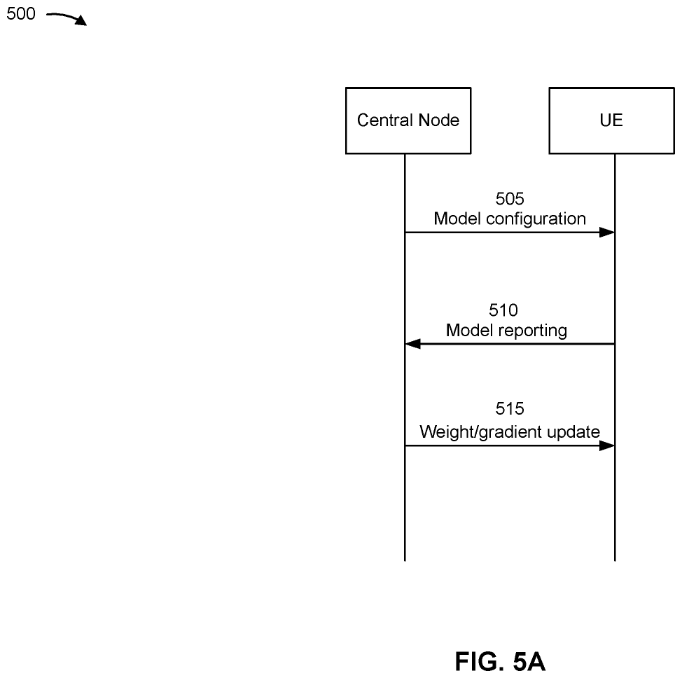

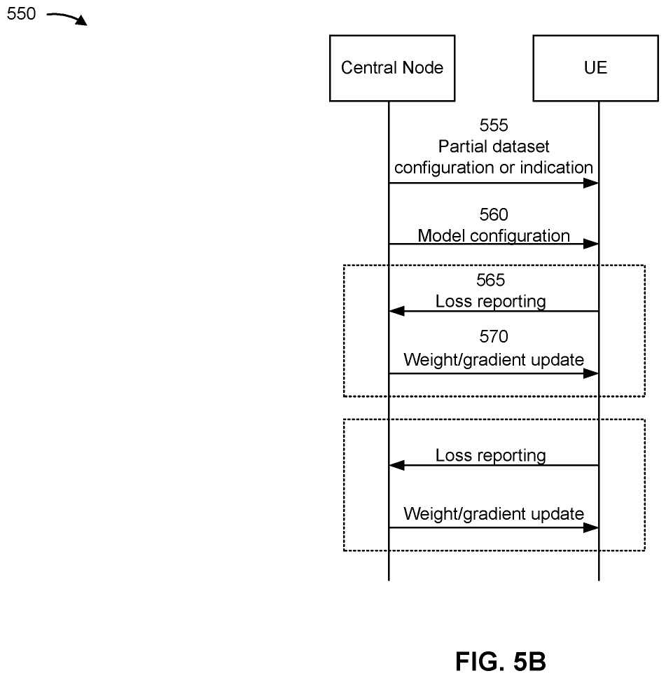

FIGS. 5A-5B are diagrams illustrating examples 500 and 550, respectively, of multi-node cooperation for distributed training, in accordance with the present disclosure.

In some examples, training (e.g., continuous training) of a machine learning model may use multi-node cooperation. Multi-node cooperation may use distributed training (also referred to as distributed learning) of the machine learning model, in which the training load for the machine learning model is distributed across multiple nodes (e.g., multiple UEs). Techniques for distributed training should account for data privacy (e.g., the local data of a node should not be shared with other nodes), limited bandwidth for exchange among nodes, constraints of processing resources of a central node, and providing model convergence for training resulting from multi-node cooperation.

One technique for distributed training includes model reporting (also referred to as model exchange). Here, a node involved in the distributed training may perform a training operation using local data to update the machine learning model. The node may report the updated model to a central node or a model manager (e.g., a network entity), rather than reporting the data used for the training. Accordingly, the central node may receive updated models from multiple nodes, as the model training load is distributed among the multiple nodes, thereby reducing a processing load at the central node. The central node may merge the reported updated models (e.g., may average or otherwise aggregate weights used by the reported updated models) from the multiple nodes.

Example 500 of FIG. 5A shows an example of a model reporting procedure between a central node (e.g., a center at which model training is performed) and a UE (e.g., a client). As shown by reference number 505, the central node may transmit, and the UE may receive, a configuration for a machine learning model. The configuration may indicate parameters for the machine learning model (e.g., variables, such as weights, that are learned from training), hyperparameters for the machine learning model (e.g., parameters, typically manually set, that control the learning process for the machine learning model), or the like. As shown by reference number 510, the UE may transmit, and the central node may receive, an updated machine learning model (i.e., model reporting). For example, the UE may update the machine learning model, as described herein, by performing a training iteration of the machine learning model using local data at the UE (e.g., performing a forward computation of the machine learning model using the local data, determining a loss value based at least in part on the forward computation, performing backpropagation of the machine learning model using the loss value, and updating the machine learning model based at least in part on the backpropagation). As shown by reference number 515, the central node may transmit, and the UE may receive, information for updating the machine learning model. For example, the information may include updated weights for the machine learning model and/or updated gradients (e.g., indicating changes in weights) relating to weights for the machine learning model. The information may be based at least in part on the central node merging multiple updated machine learning models (e.g., averaging or otherwise aggregating weights used by the updated models) reported from multiple UEs.

Another technique for distributed training includes loss reporting (also referred to as loss exchange). Here, a node involved in the distributed training may determine a loss value associated with a forward computation of an updated machine learning model using local data (e.g., perform a forward computation of the machine learning model using local data at the node and apply a loss function to the result of the forward computation to determine a loss value). The node may report the loss value to the central node, rather than reporting the updated model. Accordingly, the central node may receive local loss values from multiple nodes. The central node may aggregate, such as by averaging, the local loss values from the multiple nodes, determine (e.g., using a backpropagation of the machine learning model) one or more gradients with respect to the weights of the machine learning model, and configure, for the multiple nodes, the one or more gradients and/or one or more updated weights that are based at least in part on the gradient(s) for use in updating of the machine learning model. In one example, loss reporting for distributed training may be a type of virtual central training. Relative to model reporting, loss reporting reduces the size of transmissions to the central node, provides good model convergency (e.g., accuracy), and reduces a processing load for the central node. Loss reporting may involve a relatively high frequency of reporting to the central node (e.g., the number of reports that a node transmits to the central node corresponds to the number of epochs used for the distributed training).

In some examples, the central node may store a data set used for optimization of a machine learning model. However, processing resources of the central node may be insufficient, or otherwise limited, for performing model optimization at the central node. Moreover, multiple distributed UEs may be capable of performing model optimization locally. In a case where uplink resource constraints may limit the amount of data the UEs can transmit to the central node, loss reporting may be more efficient than model reporting.

Example 550 of FIG. 5B shows an example of loss reporting between a central node (e.g., a center at which model training is performed) and a UE (e.g., a client). As shown by reference number 555, the central node may transmit, and the UE may receive, a configuration for, or an indication of, a part of a data set to be used for optimization of a machine learning model. For example, the central node may divide the data set among the UEs participating in the distributed training, and the central node may provide a configuration to each UE for a part of the data set. As another example, the UEs may store the data set, and the central node may provide an indication to each UE indicating which part of the data set is to be used by the UE for local training. As shown by reference number 560, the central node may transmit, and the UE may receive, a configuration for a machine learning model, as described herein. As shown by reference number 565, the UE may transmit, and the central node may receive, a local loss value (i.e., a loss report) associated with a forward computation of the machine learning model at the UE. As shown by reference number 570, the central node may transmit, and the UE may receive, information for updating the machine learning model, as described herein. As shown, the central node and the UE may perform this reporting and updated procedure one or more additional times (e.g., according to a quantity of training epochs used for training the machine learning model).

Accordingly, one epoch of training for the machine learning model includes one loss reporting from the UE and one information update for the UE. As described herein, in loss reporting, only the forward loss at each UE involved in distributed training is reported in uplink (e.g., an updated model and/or local data is not reported). As a loss may be represented by a single value, the loss reporting has minimal signaling overhead. Moreover, each of the UEs involved in the distributed training may maintain the same machine learning model, thereby facilitating convergence of the machine learning model to an optimal state (e.g., in an equivalent manner as if the training was centralized). In addition, the central node may determine an aggregated loss (e.g., perform loss averaging) based on loss reporting from the UEs involved in the distributed training. For example, in an iₜₕ epoch, where a UE u reports a loss L_{i,u} and a corresponding batch size B_{i,u}, the aggregated loss may be determined according to Equation 1:

$${L}_{i} = \frac{{\sum }_{u} {L}_{i , u} {B}_{i , u}}{{\sum }_{u} {B}_{i , u}} \qquad Equation 1$$

The central node may use the aggregated loss to perform backpropagation of the machine learning model to determine one or more updated gradients relating to weights for the machine learning model and/or to determine one or more updated weights for the machine learning model.

As indicated above, FIGS. 5A-5B are provided as an example. Other examples may differ from what is described with respect to FIGS. 5A-5B.

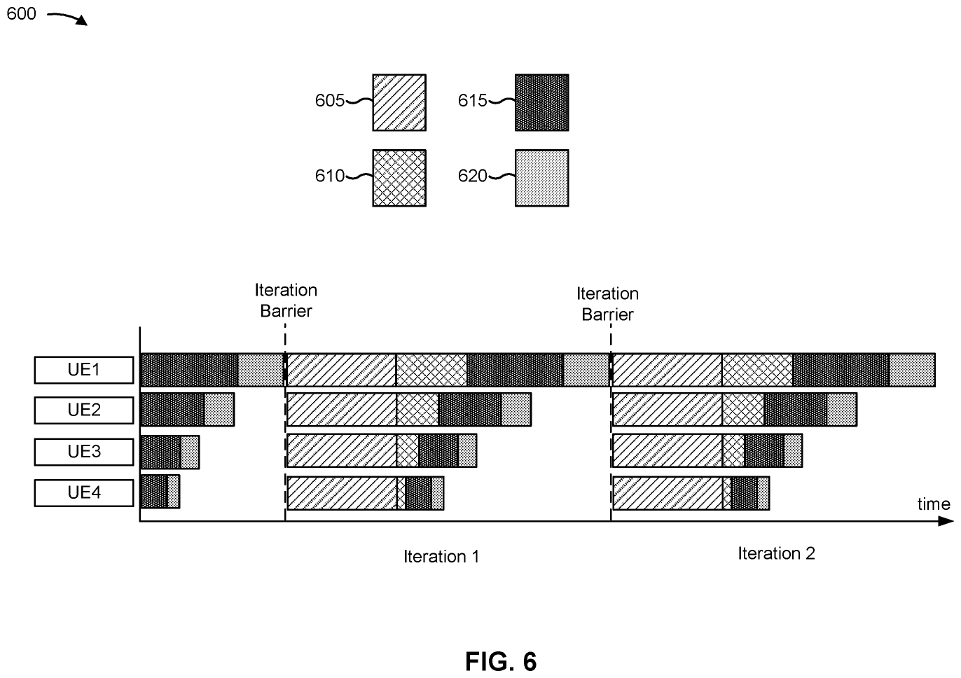

FIG. 6 is a diagram illustrating an example 600 of multi-node cooperation for distributed training, in accordance with the present disclosure.

As described herein, distributing training of a machine learning model using loss reporting is efficient and facilitates small-sized data reporting from UEs to a central node. However, as the reporting occurs in each training iteration for the machine learning model, a frequency of the reporting is high. In each training iteration, all nodes involved in the distributed training (e.g., all nodes scheduled for the distributed training) report a local loss (which can also be referred to as a local forward loss). Thus, in each training iteration, the training procedure is delayed by a last node to provide reporting.

As shown in FIG. 6, a first UE (UE1), a second UE (UE2), a third UE (UE3), and a fourth UE (UE4) may provide distributed training of a machine learning model in multiple training iterations (or epochs). A training iteration may include four operations, though in some examples more or less than four operations may be used. In a first operation 605, the central node may determine an aggregated loss value based at least in part on respective local loss values reported by the UEs, perform backpropagation of the machine learning model using the aggregated loss value to determine information for updating the machine learning model (e.g., one or more gradient values relating to weights of the machine learning model and/or one or more updated weights for the machine learning model based at least in part on the one or more gradient values). The central node may configure the information for updating the machine learning model for the UEs that provide the distributed training. In a second operation 610, each UE may locally update the machine learning model based at least in part on the information for updating the machine learning model. In a third operation 615, each UE may perform a forward computation for the updated machine learning model (e.g., use the machine learning model to determine an output based at least in part on local data). In a fourth operation 620, each UE may determine a local loss associated with the forward computation. Each UE may report a local loss value to the central node.

In example 600, the first UE may be a low-tier UE, such as a reduced capability UE, and may be unable to perform computations for a training iteration as quickly as the second, third, and fourth UEs. For example, as shown, in a first training iteration (Iteration 1) of the machine learning model, the fourth UE (as well as the second UE and the third UE) may complete computations for the first training iteration and report a local loss value before the first UE is able to complete computations for the first training iteration and report a local loss value. As shown, the fourth UE is unable to begin to perform computations (e.g., operations 610, 615, and 620) for a second training iteration (Iteration 2) until the first UE has reported a local loss value, as operations for the second training iteration (e.g., operation 605) are based at least in part on local loss values reported by each of the UEs. Thus, a latency of the distributed training is constrained by the first UE (e.g., the slowest UE), and the fourth UE is unable fully utilize superior computing capabilities of the fourth UE.

As described herein, distributed training using loss reporting is desirable as loss reporting reduces uplink resource usage, is high performing (e.g., provides fast and stable model convergence), and provides robust model generalization (e.g., because the forward computations and loss computations are in accordance with the diverse hardware settings of the different UEs that provide the distributed training). However, as also described herein, loss reporting has a high reporting frequency over many training iterations (e.g., dozens of iterations). Thus, the training iterations, constrained by the speed of the slowest UE, may increase the latency of the distributed training and reduce the efficiency of the distributed training.

In some techniques and apparatuses described herein, a UE involved in distributed training of a machine learning model may transmit a local loss value, for a training iteration of the machine learning model, in a time window for (e.g., associated with) reporting the local loss value for the training iteration. The time window may have an ending after which the local loss value for the training iteration is not to be reported. In some aspects, the time window may be prior to expiration of a timer that runs from a beginning of a period in which the machine learning model is updated for the training iteration. In some aspects, the time window may be in an occasion of a periodic resource for loss reporting. In some aspects, the time window may start after a time gap from an end of the UE's reception of information for updating the machine learning model for the training iteration.

Accordingly, if the UE is unable to report the local loss value (e.g., because computation of the local loss value is not complete) by the ending of the time window (e.g., prior to expiration of the timer, in the occasion of the periodic resource, or in a resource after the time gap), then the UE may refrain from reporting the local loss value for the training iteration. However, even if the UE does not report local loss values for one or more training iterations, the UE may continue to receive information for updating the machine learning model (e.g., that is based at least in part on the local loss values from one or more UEs that were able to report in the time window) for the one or more iterations, and therefore the UE may maintain the same machine learning model as other UEs involved in the distributed training.

In this way, the distributed training is not constrained by a last-reporting UE, and the distributed training may be completed with improved speed. Accordingly, an accurate machine learning model may be obtained faster, and the performance of communications that utilize the machine learning model (e.g., CSI reporting) may be improved. Moreover, the techniques and apparatuses described herein conserve processing resources and power resources involved in training a machine learning model, as the ending of the time window for loss reporting provides a cutoff for lengthy training computations that otherwise may continue unconstrained.

As indicated above, FIG. 6 is provided as an example. Other examples may differ from what is described with respect to FIG. 6.

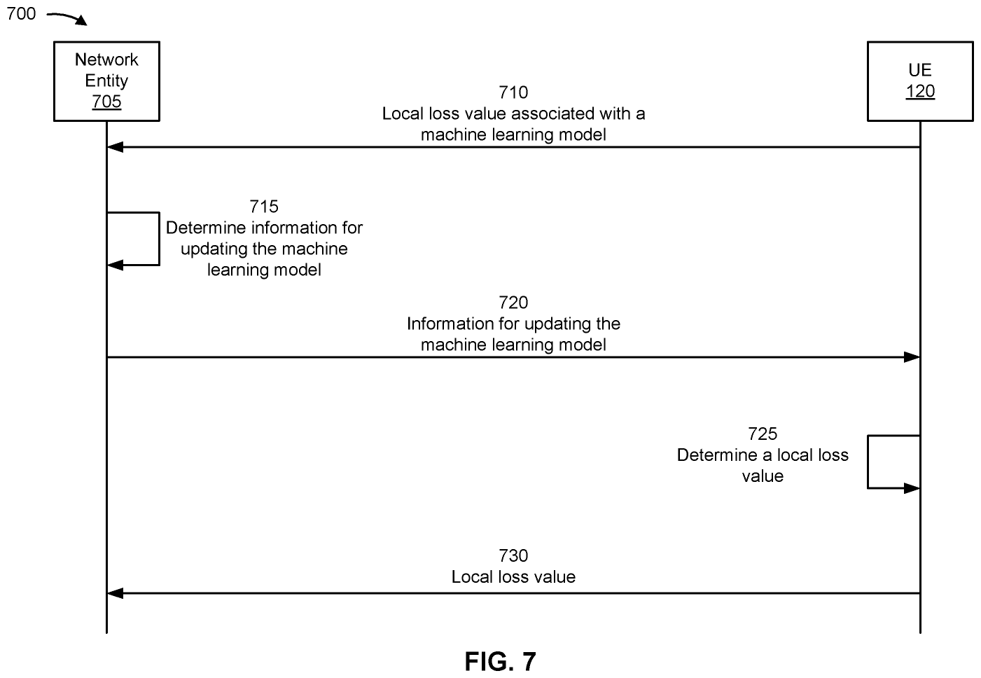

FIG. 7 is a diagram illustrating an example 700 associated with loss reporting for distributed training of a machine learning model, in accordance with the present disclosure. As shown in FIG. 7, example 700 relates to communications of a network entity 705 and a UE 120. The network entity 705 (e.g., a central node, as described herein) may be, or may include, a base station 110 or one or more components of a disaggregated base station, such as a CU 310, a DU 330, an RU 340, or the like. In some aspects, the machine learning model may provide CSI encoding and/or CSI decoding.

As shown by reference number 710, the UE 120 may transmit, and the network entity 705 may receive (e.g., obtain), a local loss value associated with a machine learning model. For example, the network entity 705 may receive respective local loss values reported by one or more UEs (e.g., a plurality of UEs) that provide distributed training for the machine learning model, as described herein. A “local” loss value may refer to a loss value computed by a particular UE. For example, the UE may determine the local loss value as a result of a loss function applied to a forward computation of the machine learning model using local data of the UE, as described herein.

As shown by reference number 715, the network entity 705 may determine information for updating the machine learning model for a training iteration of the machine learning model. The information may include an aggregated loss value, one or more gradients relating to weights for the machine learning model, one or more updated weights for the machine learning model, and/or one or more other parameters that may be updated for training of the machine learning model. In some aspects, the network entity 705 may determine the aggregated value based at least in part on the local loss values reported to the network entity 705 by the UEs that provide the distributed training. Furthermore, the aggregated loss value may be based at least in part on batch sizes used by the UEs for determining the local loss values (e.g., in accordance with Equation 1). Moreover, the network entity 705 may perform backpropagation of the machine learning model using the aggregated loss value to determine the one or more gradients, as described herein. In addition, the network entity 705 may determine the one or more updated weights based at least in part on the gradient(s), as described herein.

As shown by reference number 720, the network entity 705 may transmit (e.g., provide or output), and the UE 120 may receive, the information for updating the machine learning model associated with the training iteration of the machine learning model. For example, all of the UEs that provide the distributed training may receive the information for updating the machine learning model. Thus, the information for updating the machine learning model may be broadcast or multicast to the UEs, or each of the UEs may receive separate unicast transmissions of the information for updating the machine learning model.

As shown by reference number 725, the UE 120 may determine a local loss value, for the training iteration of the machine learning model, based at least in part on the information for updating the machine learning model. For example, each of the UEs that provide the distributed training may determine a respective local loss value. To determine the local loss value, the UE 120 may update the machine learning model using the information for updating the machine learning model (e.g., the UE 120 may update one or more weights for the machine learning model). Furthermore, the UE 120 may perform a forward computation using the machine learning model (e.g., based at least in part on local data of the UE 120) after updating the machine learning model. The UE 120 may determine the local loss value based at least in part on the forward computation (e.g., by applying a loss function to the forward computation).

As shown by reference number 730, the UE 120 may transmit, and the network entity 705 may receive (e.g., obtain), the local loss value for the training iteration of the machine learning model. For example, each of the UEs that provide the distributed training may transmit respective local loss values.

In some aspects, the UE 120 may transmit the local loss value and information indicating a batch size (e.g., used by the UE 120 for the training iteration). For example, the UE 120 may transmit the local loss value and the information indicating the batch size together for the training iteration (e.g., for each training iteration, the UE 120 may transmit a local loss value with information indicating a batch size). In some aspects, to transmit the information indicating the batch size, the UE 120 may transmit, prior to a first training iteration of the machine learning model, information indicating a size of local data at the UE 120 (e.g., a batch size). Accordingly, the UE 120 may refrain from transmitting information indicating the batch size for subsequent training iterations of the machine learning model. In some aspects, the network entity 705 may transmit, and the UE 120 may receive, a configuration for the batch size, in which case the UE 120 may refrain from transmitting the information indicating the batch size. Here, the UE 120 may refrain from transmitting the local loss value when the configured batch size is greater than a size of local data at the UE 120 for the training iteration of the machine learning model (i.e., the size of the local data is less than the configured batch size). Moreover, the UE 120 may select a set of data samples, from the local data, for the training iteration of the machine learning model when the batch size is less than a size of the local data (i.e., the size of the local data is greater than the configured batch size).

In some aspects, the UE 120 may transmit the local loss value in a time window (e.g., an opportunity) for (e.g., associated with) reporting (and reception of) the local loss for the training iteration. The time window may be a time period, a time domain resource of a resource, or the like. Thus, the time window may have (in addition to a start) an ending after which the local loss value for the training iteration is not reported. That is, if the UE 120 does not transmit the local loss value by the ending of the time window (e.g., because the UE 120 has not completed computation of the local loss value by the ending of the time window), then the UE 120 may abort local loss computations, discard local loss computations, or otherwise refrain from transmitting the local loss value for that training iteration (e.g., the UE 120 may refrain from transmitting the local loss value responsive to the ending of the time window occurring prior to determination of the local loss value). Thus, an update to the machine learning model for a subsequent training iteration may be based at least in part on only the local loss values that were reported (e.g., even if only one UE was able to report a local loss value).

In some aspects, the time window for reporting may be (e.g., may end) prior to an expiration of a timer for (e.g., associated with) one training iteration of the machine learning model. The timer may be initiated by the UE 120. The timer may run from (e.g., a start of the timer is at) a beginning of a period in which the machine learning model is updated by the UE 120 using the information for updating the machine learning model. If the timer expires prior to an end of the local loss calculation at the UE 120 (e.g., a time period from the beginning of the period in which the machine learning model is updated to the end of the local loss calculation is greater than a length of the timer), then the UE 120 does not report the local loss value. In some aspects, the UE 120 may receive a configuration for the timer (e.g., for a length of the timer).

Moreover, the time window for reporting may be prior to an expiration of a timer for (e.g., associated with) loss aggregation. The timer may be initiated by the network entity 705. The timer may run from (e.g., a start of the timer is at) a beginning of transmission of the information for updating the machine learning model. The network entity 705 may monitor for loss reporting from UEs that provide the distributed training while the timer is running. The network entity 705 may determine an aggregated loss value, as described herein, based at least in part on local loss values reported by UEs after an earlier of: reception of all local loss values for the training iteration of the machine learning model (e.g., reception of local loss values from all UEs that provide the distributed training for the machine learning model,) or the expiration of the timer. In some aspects, the network entity 705 may determine the aggregated loss value based at least in part on local loss values received prior to the expiration of the timer, and the network entity 705 may ignore local loss values received after the expiration of the timer for purposes of determining the aggregated loss value. In some aspects, the network entity 705 may determine the aggregated loss value based at least in part on local loss values received prior to the expiration of the timer and local loss values received for a prior training iteration of the machine learning model. For example, if local loss values for one or more UEs are not received prior to the expiration of the timer, then the network entity 705 may determine the aggregated loss values using local loss values received from those one or more UEs for a prior training iteration (e.g., as a substitute).

In some aspects, the time window for reporting may be in an occasion of a periodic resource for (e.g., associated with) loss reporting. The periodic resource for loss reporting may be associated with a different periodic resource for update information configuration, in which the information for updating the machine learning model is transmitted by the network entity 705 and received by the UE 120. In some aspects, the network entity 705 may transmit, and the UE 120 may receive, a configuration for a periodic resource pattern that indicates the periodic resource for loss reporting and the periodic resource for update information configuration.

In some aspects, the time window for reporting may be (e.g., may start) after a time gap from an end of reception of the information for updating the machine learning model (as well as after a time gap from transmission of the information). For example, the end of the reception of the information and the beginning of the transmission of the local loss value may define a timeline (e.g., a constant timeline) that defines the time gap. In some aspects, the network entity 705 may transmit, and the UE 120 may receive, a configuration for the time gap/timeline.

The network entity 705 may determine new information for updating the machine learning model based at least in part on the local loss values reported by UEs that provide the distributed training, as described in connection with reference number 730, thereby starting a new training iteration of the machine learning model, as described herein. In some aspects, multiple training iterations may be performed to train the machine learning model.

As indicated above, FIG. 7 is provided as an example. Other examples may differ from what is described with respect to FIG. 7.

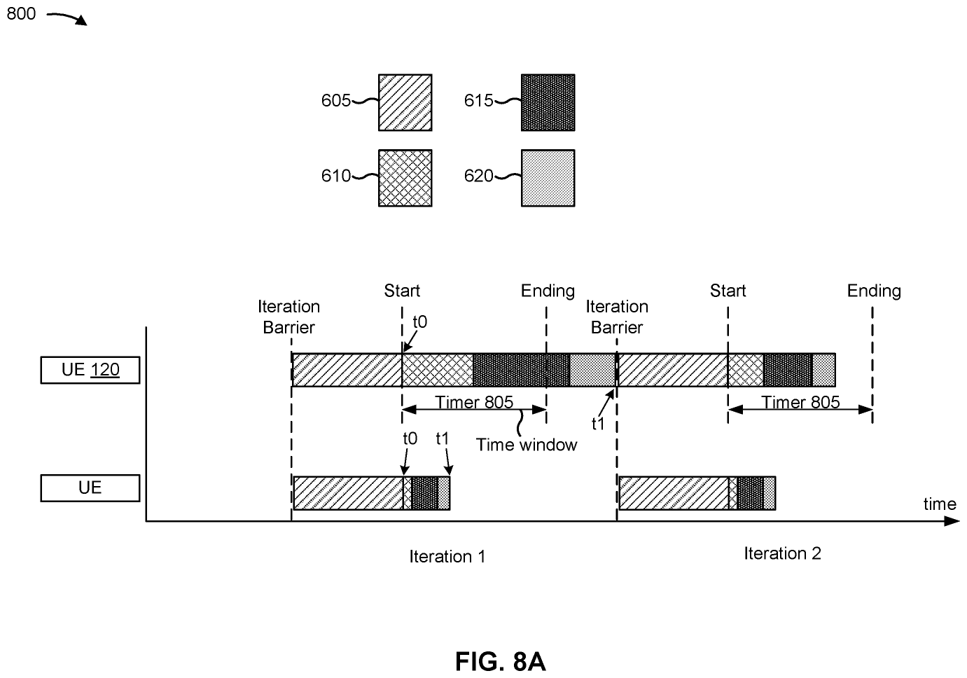

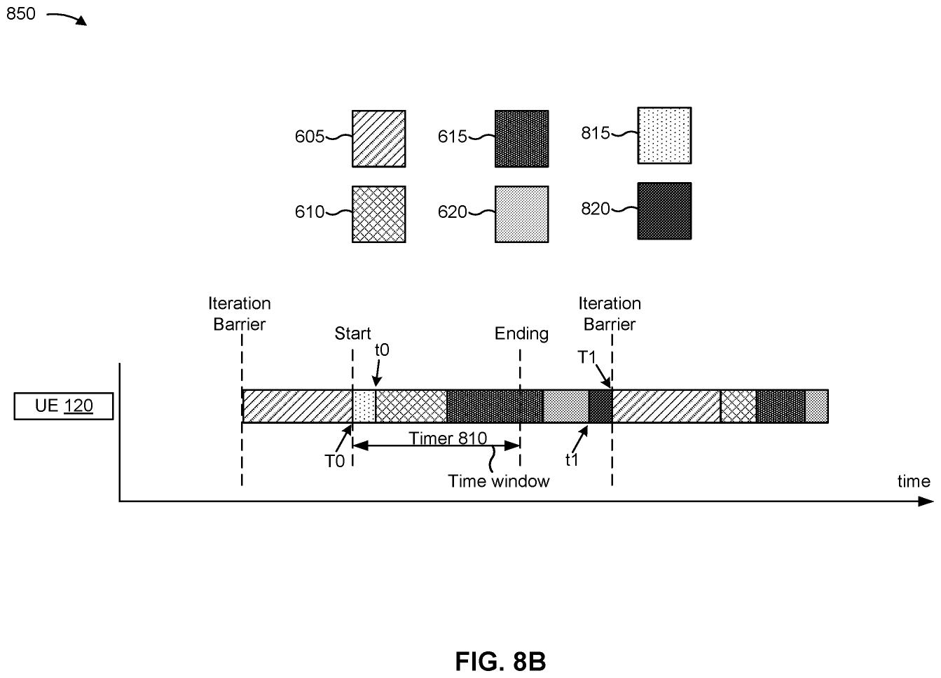

FIGS. 8A-8B are diagrams illustrating an example 800 associated with loss reporting for distributed training of a machine learning model, in accordance with the present disclosure. In FIGS. 8A-8B, a time window for reporting a local loss value, as described in connection with FIG. 7, may be (e.g., may start and end) prior to an expiration of a timer.

In particular, in FIG. 8A, the UE 120 may transmit, or refrain from transmitting, a local loss value for a training iteration of a machine learning model in accordance with a timer 805 for one training iteration (e.g., one epoch). As shown, a training iteration of the machine learning model may include operations 605, 610, 615, and 620, as described herein.

As shown in FIG. 8A, a time to may represent a beginning of an update period (e.g., a beginning of an operation 610) for the machine learning model, as described herein, and a time t1 may represent an end of a loss calculation (e.g., an end of an operation 620) for the machine learning model. If a time period from t0 to t1 is greater than a length of the timer 805, then the UE 120 may refrain from transmitting the local loss value. Whether the UE 120 is able to perform these operations (e.g., operations 610, 615, and 620) before expiration of the timer 805 may be based at least in part on one or more capabilities of the UE 120, a computation time needed by the UE 120 in a particular training iteration, or the like.

As shown in FIG. 8A, in a first training iteration (Iteration 1), the UE 120 may not complete model updating (operation 610), forward computation (operation 615), and local loss value computation (operation 620) before expiration of the timer 805. Accordingly, the UE 120 may discard the computations and refrain from loss reporting for the first iteration. Moreover, the UE 120 may receive, from the network entity 705, new information for updating the machine learning model (e.g., one or more new gradient values and/or one or more weights) in a second iteration (Iteration 2). In the second iteration, the UE 120 may restart computations and complete model updating (operation 610), forward computation (operation 615), and local loss value computation (operation 620) before expiration of the timer 805. Accordingly, the UE 120 may report the local loss value to the network entity 705 for the second iteration. As also shown in FIG. 8A, another UE (e.g., with greater capability than the UE 120), may successfully complete model updating, forward computation, and local loss value computation before expiration of the timer 805 in the first iteration and in the second iteration. Accordingly, the other UE may perform loss reporting in both iterations.

In this way, each UE 120 that provides the distributed training for the machine learning model may maintain the same machine learning model and participate in the distributed training (e.g., even if one or more UEs 120 must refrain from loss reporting in one or more training iterations). Moreover, a time needed for the distributed training may be represented by (timer+T_c+OTA)×N, where T_c represents a time for loss averaging and backpropagation at the network entity 705 (e.g., operation 605), OTA represents an over-the-air delay (e.g., a propagation delay), which in some cases may be ignored, and N represents the number of training iterations that are used for the distributed training.

In FIG. 8B, the network entity 705 may monitor for loss reporting from the UEs that provide the distributed training for the machine learning model in accordance with a timer 810 for loss aggregation. As shown in FIG. 8B, a time TO may represent a beginning of configuration (e.g., of transmission) of information for updating the machine learning model and a time T1 may represent an end of reception of one or more local loss values (e.g., an end of loss reporting). The timer 810 may be defined to run from T0 to T1. While the timer 810 is running, the network entity 705 may monitor for loss reporting from the UEs that provide the distributed training for the machine learning model. Upon expiration of the timer 810, the network entity 705 may not expect further loss reporting from the UEs.

In some aspects, a length of the timer 810 may be a particular value that is provisioned for the network entity 705. In some aspects, a length of the timer 810 may be derived by implementation of the network entity 705. For example, the network entity 705 may derive (e.g., determine) a length of the timer 810 based at least in part on the timer 805 for one training iteration used by the UE 120. In particular, compared to the timer 805 for one training iteration used by the UE 120, the timer 810 for loss aggregation may include a time associated with the propagation delay 815 in downlink for configuration of information for updating the machine learning model (e.g., a time from T0 to t0) and a time associated with the propagation delay 820 in uplink for loss reporting (e.g., a time from t1 to T1). The uplink and downlink propagation delays may be relatively small.

In some aspects, the network entity 705 may determine an aggregated loss value and perform backpropagation of the machine learning model after a condition is satisfied. That is, the network entity 705 may begin to compute the aggregated loss value only after the condition is satisfied. In some aspects, the condition may be that all of the UEs that provide the distributed training for the machine learning model (e.g., all scheduled UEs in the distributed training) have reported a local loss value. In some aspects, the condition may be that the timer 810 for loss aggregation has expired.

In some aspects, the network entity 705 may perform loss aggregation and backpropagation by implementation of the network entity 705. For example, the network entity 705 may determine the aggregated loss value based only on local loss values reported prior to the expiration of the timer 810 for loss aggregation, and the network entity 705 may ignore local loss values reported after the expiration of the timer 810 for purposes of determining the aggregated loss value. In some aspects, the network entity 705 may determine the aggregated loss value based at least in part on local loss values reported prior to the expiration of the timer 810 and local loss values reported in connection with a prior training iteration of the machine learning model. For example, if local loss values for one or more UEs are not reported prior to the expiration of the timer 810, then the network entity 705 may determine the aggregated loss value using local loss values received from those one or more UEs in connection with a prior training iteration.

As indicated above, FIG. 8A-8B are provided as an example. Other examples may differ from what is described with respect to FIG. 8A-8B.

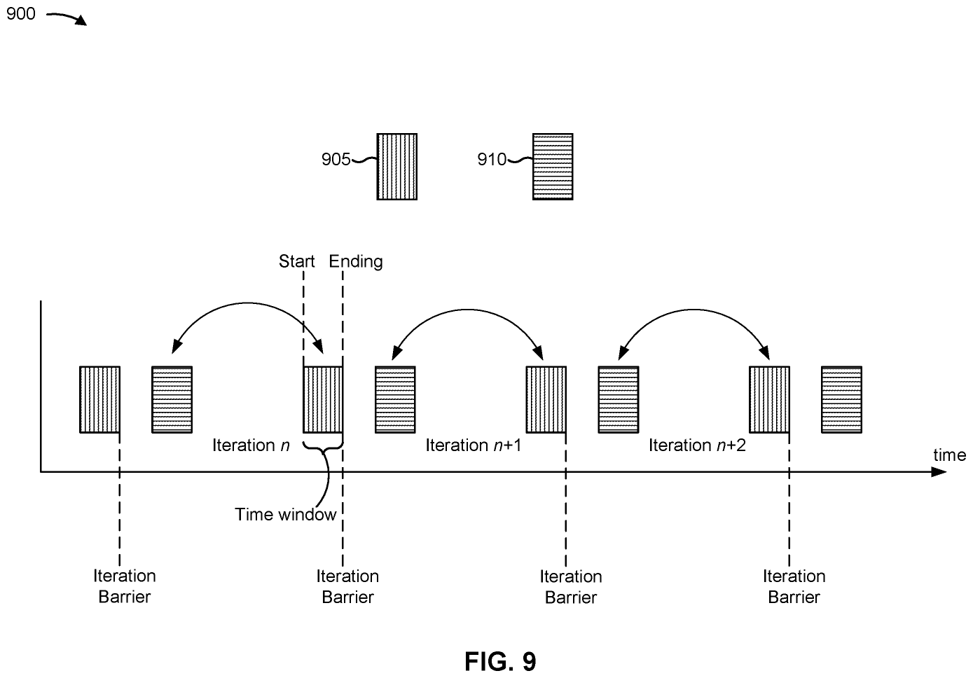

FIG. 9 is a diagram illustrating an example 900 associated with loss reporting for distributed training of a machine learning model, in accordance with the present disclosure. In FIG. 9, a time window for reporting a local loss value, as described in connection with FIG. 7, may be an occasion of a periodic resource for loss reporting (e.g., the time window may coincide with a time resource of the occasion of the periodic resource), as described herein.

In particular, in FIG. 9, the UE 120 may transmit, or refrain from transmitting, a local loss value for a training iteration of a machine learning model in accordance with a periodic reporting resource pattern. A unit of the periodic pattern may include an occasion 905 for loss reporting in uplink and an occasion 910 for update information configuration (e.g., configuration of one or more gradient values and/or one or more weights) in downlink. An occasion 905 for loss reporting may include a time domain resource for loss reporting (e.g., for transmission by the UE 120 of a local loss value). An occasion 910 for update information configuration may include a time domain resource for update information configuration (e.g., for reception by the UE 120 of information for updating the machine learning model). In some aspects, a training iteration may use cascade processing.

In some aspects, the network entity 705 may perform a broadcast or multicast transmission of information that identifies the periodic pattern to the UEs that provide the distributed training of the machine learning model (e.g., all scheduled UEs in the distributed training). All UEs that provide the distributed training may monitor the occasions 910 for an update information configuration in order to receive information for updating the machine learning model. Otherwise, if a UE were to skip receiving information for updating the machine learning model for a training iteration, the UE would lose the training iteration and be unable to participate in the distributed training of the machine learning model.

As shown in FIG. 9, following an occasion 910 in which the UE 120 receives information for updating the machine learning model, the UE 120 may transmit, in the next occasion 905 for loss reporting, a local loss value that is associated with the information (e.g., associated with the latest configuration of information for updating the machine learning model). For example, based at least in part on the information, the UE 120 may compute the local loss value, as described herein, and the UE 120 may transmit the local loss value in the occasion 905 for loss reporting if the local loss value is ready for reporting by the occasion 905 for loss reporting (e.g., if the UE 120 has completed computation of the local loss value before the occasion 905). The UE 120 should make best efforts (e.g., by prioritizing local loss value computation) to report a local loss value for a training iteration in the resource for loss reporting for the training iteration. However, if the UE 120 is unable to report a local loss value (e.g., if the UE 120 has not completed computation of the local loss value) by an occurrence of the resource (e.g., an occasion 905) for reporting the local loss value, then the UE 120 may report a zero value, a blank value, or the like, in the resource or otherwise refrain from reporting a local loss value in the resource.

In this way, a time needed for the distributed training may be represented by unit time×N, where unit time represents a cycle time for one cycle of the periodic pattern (where one cycle includes an occasion 910 for update information configuration and an occasion 905 for loss reporting), and N represents the number of training iterations that are used for the distributed training (shown as Iteration n, Iteration n+1, and Iteration n+2 in FIG. 9).

As indicated above, FIG. 9 is provided as an example. Other examples may differ from what is described with respect to FIG. 9.

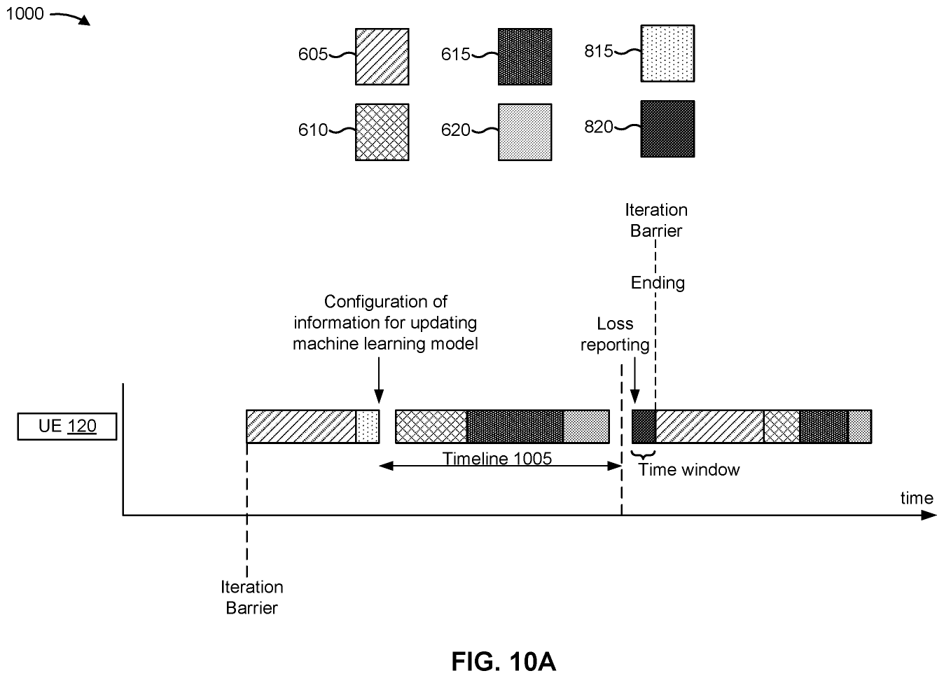

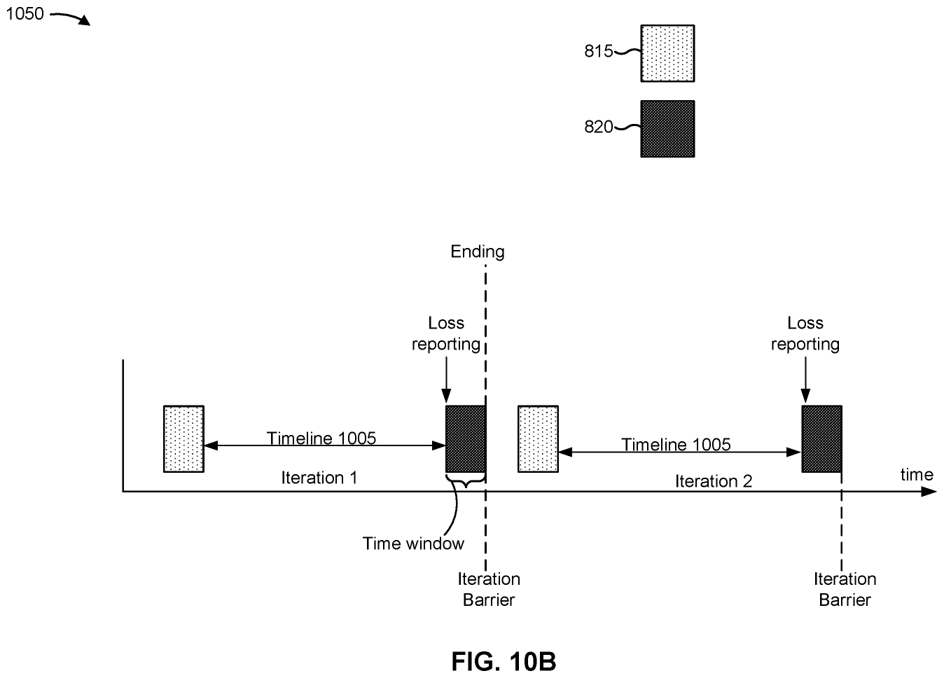

FIGS. 10A-10B are diagrams illustrating examples 1000 and 1050 associated with loss reporting for distributed training of a machine learning model, in accordance with the present disclosure. In FIG. 10A, a time window for reporting a local loss value, as described in connection with FIG. 7, may be (e.g., may start) after a time gap from an end of reception of information for updating a machine learning model (as well as after a time gap from transmission of the information), as described herein.

In particular, in FIG. 10A, the UE 120 may transmit, or refrain from transmitting, a local loss value for a training iteration of a machine learning model in accordance with a timeline 1005 for loss reporting. The timeline 1005 may refer to the time gap between an end of reception of (e.g., configuration of) information for updating the machine learning model (shown by propagation delay 815) and a beginning of transmission of a local loss value (shown by propagation delay 820). For example, after the UE 120 receives information for updating the machine learning model, the UE 120 may transmit a local loss value (e.g., based at least in part on the information for updating the machine learning model) after the time gap.

The timeline 1005 may be constant. For example, the network entity 705 may provide a configuration for the timeline 1005 to the UE 120, and the UE 120 may use the configured timeline 1005 for each training iteration of the machine learning model (e.g., until a new configuration is received). As an example, as shown in FIG. 10B, the UE 120 may perform loss reporting according to the timeline 1005 in a first training iteration (Iteration 1), in a second training iteration (Iteration 2), and so forth.

In this way, the network entity 705 may dynamically configure (e.g., schedule) reception at the UE 120 of information for updating the machine learning model, to thereby flexibly cause a training iteration of the machine learning model at the UE 120. In some aspects, the timeline 1005 may be based at least in part (e.g., may reserve) a least amount of time needed for UE processing, which may be beneficial to a UE with a high processing burden and/or a low-tier UE.

As indicated above, FIGS. 10A-10B are provided as examples. Other examples may differ from what is described with respect to FIGS. 10A-10B.

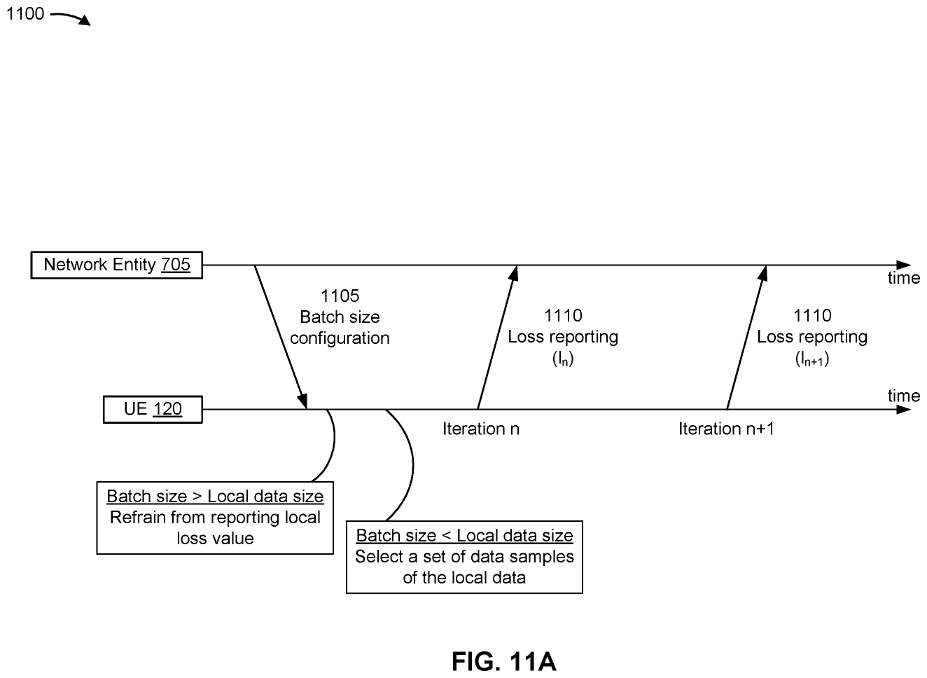

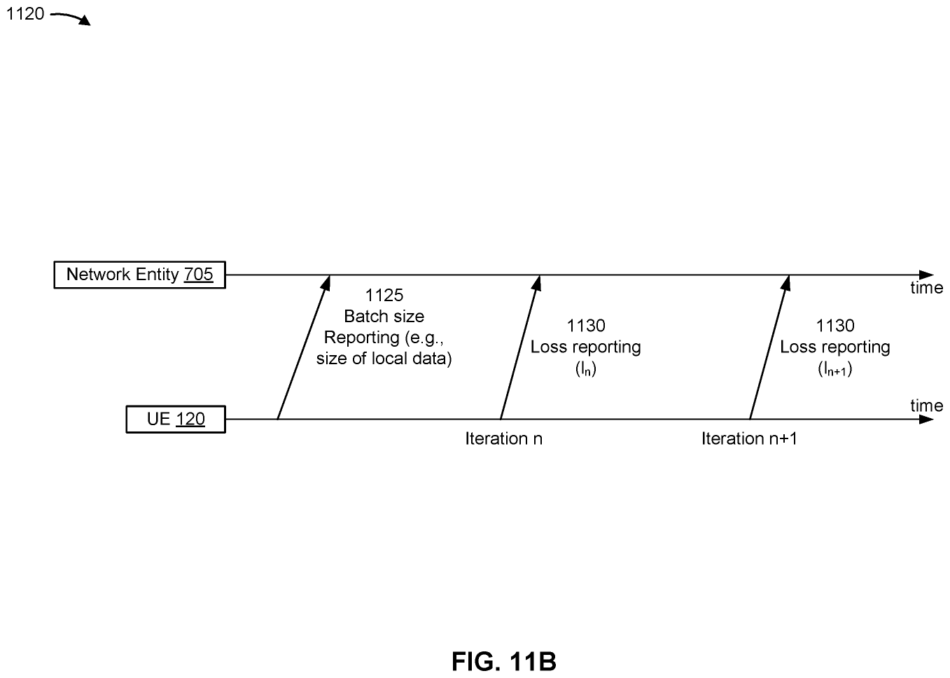

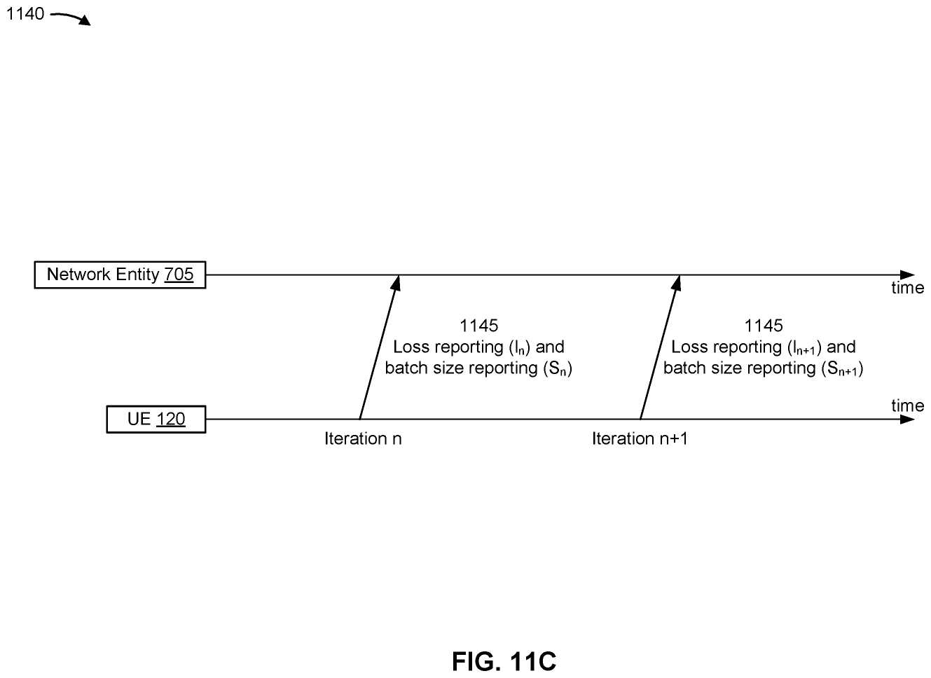

FIGS. 11A-11C are diagrams illustrating examples 1100, 1120, and 1140, respectively, associated with loss reporting for distributed training of a machine learning model, in accordance with the present disclosure. As shown in FIGS. 11A-11C, examples 1100, 1120, and 1140 relate to communications of a network entity 705 and a UE 120, as described in connection with FIG. 7.

As shown in FIG. 11A, the UE 120 may use a batch size for a training iteration of a machine learning model that is configured by the network entity 705. For example, as shown by reference number 1105, the network entity 705 may transmit, and the UE 120 may receive, a configuration for a batch size of data to be used for one or more training iterations of the machine learning model. Here, the UE 120 may refrain from reporting a batch size to the network entity 705 (e.g., the network entity 705 does not receive information indicating a batch size from the UE 120 based at least in part on transmitting the configuration). In some aspects, if a size of local data at the UE 120, for a training iteration of the machine learning model, is less than the configured batch size, the UE 120 may refrain from reporting a local loss value, but the UE 120 may monitor for, and receive, information for updating the machine learning model from the network entity 705. In some aspects, if a size of the local data is greater than the configured batch size, the UE 120 may select a set of data samples, of the local data, that is equivalent in size to the batch size, organize the set of data samples for computation, and perform computation of a local loss value based at least in part on the set of data samples. As shown by reference number 1110, the UE 120 may transmit a local loss value for one or more training iterations of the machine learning model, where the local loss value is computed based at least in part on the configured batch size

As shown in FIG. 11B, and by reference number 1125, the UE 120 may transmit, and the network entity 705 may receive, information indicating a size of available local data at the UE 120. For example, the information may indicate a batch size of data to be used by the UE 120 (e.g., the UE 120 may report the batch size to the network entity 705). The UE 120 may transmit the information prior to a first training iteration of the machine learning model (e.g., at a beginning of the distributed training). Accordingly, in training iterations of the machine learning model, the UE 120 may refrain from reporting the batch size. In other words, the batch size reported by the UE 120 prior to the first training iteration is applicable to each training iteration. As shown by reference number 1130, the UE 120 may transmit a local loss value for one or more training iterations of the machine learning model, where the local loss value is computed based at least in part on the reported batch size.

As shown in FIG. 11C, and by reference number 1145, the UE 120 may transmit, and the network entity 705 may receive, a local loss value and information indicating a batch size of data that is to be used, together, for a training iteration of the machine learning model. That is, the UE 120 may report (e.g., always report) a local loss value and a corresponding batch size for each training iteration of the machine learning model. For example, in a first iteration (Iteration 1), the UE 120 may transmit a first local loss value (Iₙ) and information indicating a first batch size (Sₙ). Continuing with the example, in a second iteration (Iteration 2), the UE 120 may transmit a second local loss value (Iₙ₊₁) and information indicating a second batch size (Sₙ₊₁). In this way, the batch size for the forward computation may be dynamically adjusted across training iterations of the machine learning model, with some additional signaling overhead.

As indicated above, FIG. 11A-11C are provided as an example. Other examples may differ from what is described with respect to FIG. 11A-11C.

FIG. 12 is a diagram illustrating an example process 1200 performed, for example, by a UE, in accordance with the present disclosure. Example process 1200 is an example where the UE (e.g., UE 120) performs operations associated with loss reporting for distributed training of a machine learning model.

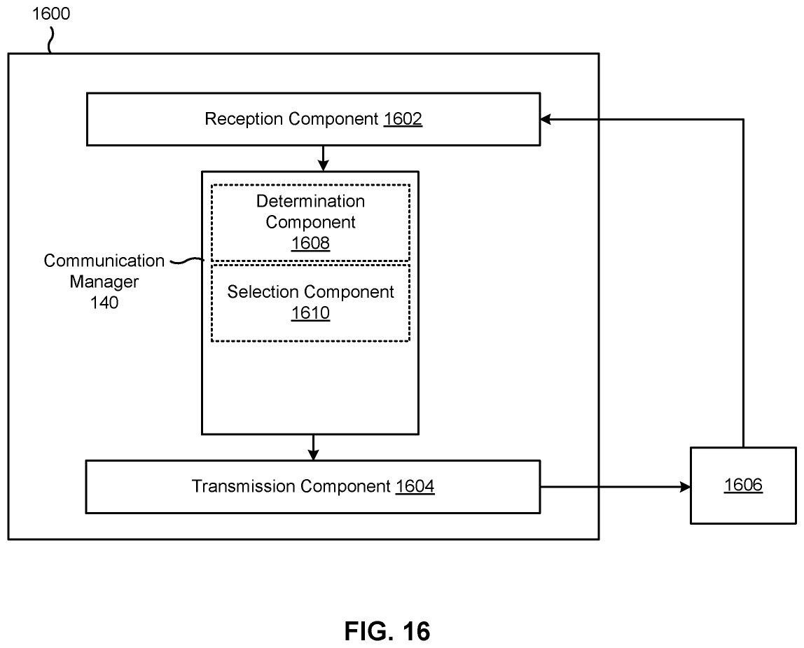

In some aspects, process 1200 may include receiving a configuration for a timer, a periodic resource pattern, or a time gap (block 1202). For example, the UE (e.g., using communication manager 140 and/or reception component 1602, depicted in FIG. 16) may receive a configuration for a timer, a periodic resource pattern, or a time gap, as described above.

As shown in FIG. 12, in some aspects, process 1200 may include receiving information to update a machine learning model associated with a training iteration of the machine learning model (block 1210). For example, the UE (e.g., using communication manager 140 and/or reception component 1602, depicted in FIG. 16) may receive information to update a machine learning model associated with a training iteration of the machine learning model, as described above.

As further shown in FIG. 12, in some aspects, process 1200 may include transmitting a local loss value based at least in part on the training iteration of the machine learning model within a time window to report the local loss value for the training iteration, the time window having an ending (block 1220). For example, the UE (e.g., using communication manager 140 and/or transmission component 1604, depicted in FIG. 16) may transmit a local loss value based at least in part on the training iteration of the machine learning model within a time window to report the local loss value for the training iteration, the time window having an ending, as described above. In some aspects, process 1200 may include refraining from transmitting the local loss value responsive to the ending of the time window occurring prior to determination of the local loss value (block 1222). For example, the UE (e.g., using communication manager 140) may refrain from transmitting the local loss value responsive to the ending of the time window occurring prior to determination of the local loss value, as described above.

Process 1200 may include additional aspects, such as any single aspect or any combination of aspects described below and/or in connection with one or more other processes described elsewhere herein.

In a first aspect, the time window is prior to an expiration of a timer for one training iteration of the machine learning model.

In a second aspect, alone or in combination with the first aspect, a start of the timer is at a beginning of a period in which the machine learning model is to be updated using the information to update the machine learning model.

In a third aspect, alone or in combination with one or more of the first and second aspects, process 1200 includes receiving a configuration for the timer.

In a fourth aspect, alone or in combination with one or more of the first through third aspects, the time window is an occasion of a periodic resource.

In a fifth aspect, alone or in combination with one or more of the first through fourth aspects, the information to update the machine learning model is received in an occasion of a different periodic resource.

In a sixth aspect, alone or in combination with one or more of the first through fifth aspects, process 1200 includes receiving a configuration for a periodic resource pattern that indicates the periodic resource and the different periodic resource.

In a seventh aspect, alone or in combination with one or more of the first through sixth aspects, the time window starts after a time gap from an end of reception of the information to update the machine learning model.

In an eighth aspect, alone or in combination with one or more of the first through seventh aspects, process 1200 includes receiving a configuration for the time gap.

In a ninth aspect, alone or in combination with one or more of the first through eighth aspects, process 1200 includes receiving a configuration for a batch size of data to be used for one or more training iterations of the machine learning model.

In a tenth aspect, alone or in combination with one or more of the first through ninth aspects, transmitting the local loss value includes refraining from transmitting the local loss value responsive to the batch size being greater than a size of local data for the training iteration of the machine learning model.

In an eleventh aspect, alone or in combination with one or more of the first through tenth aspects, process 1200 includes selecting a set of data samples from local data for the training iteration of the machine learning model responsive to the batch size being less than a size of the local data.

In a twelfth aspect, alone or in combination with one or more of the first through eleventh aspects, process 1200 includes transmitting, prior to a first training iteration of the machine learning model, information indicating a size of local data for training the machine learning model.

In a thirteenth aspect, alone or in combination with one or more of the first through twelfth aspects, transmitting the local loss value includes transmitting the local loss value and information indicating a batch size of data to be used for the training iteration together in one transmission.

In a fourteenth aspect, alone or in combination with one or more of the first through thirteenth aspects, transmitting the local loss value includes refraining from transmitting the local loss value responsive to the ending of the time window occurring prior to determination of the local loss value.

In a fifteenth aspect, alone or in combination with one or more of the first through fourteenth aspects, the information to update the machine learning model includes at least one of one or more gradient values relating to one or more weights for the machine learning model, or the one or more weights for the machine learning model.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110, CU 310, DU 330, RU 340, network entity 705, or the like) performs operations associated with loss reporting for distributed training of a machine learning model.

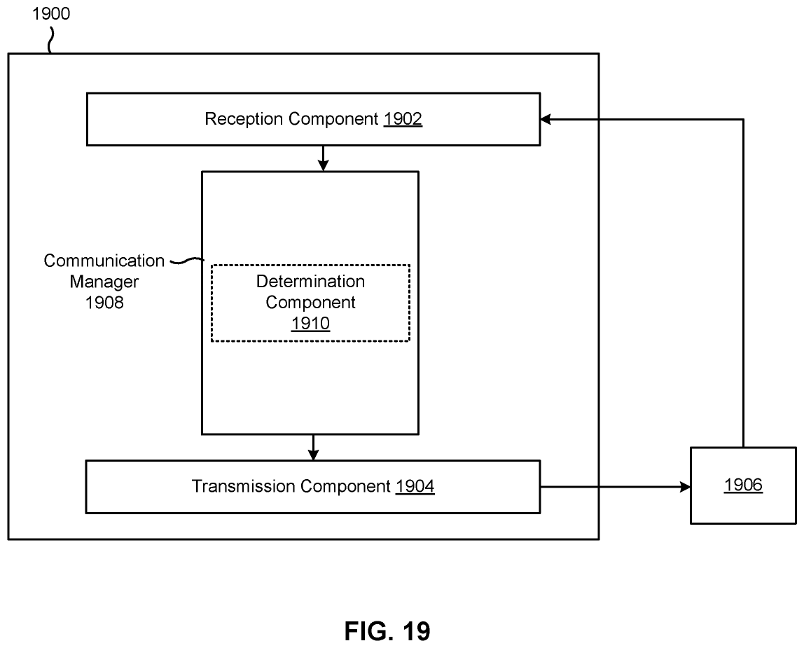

In some aspects, process 1300 may include transmitting (e.g., outputting or providing) a configuration for a timer, a periodic resource pattern, or a time gap (block 1302). For example, the network entity (e.g., using communication manager 1908 and/or transmission component 1904, depicted in FIG. 19) may transmit a configuration for a timer, a periodic resource pattern, or a time gap, as described above.

As shown in FIG. 13, in some aspects, process 1300 may include transmitting (e.g., outputting or providing) information to update a machine learning model associated with a training iteration of the machine learning model (block 1310). For example, the network entity (e.g., using communication manager 1908 and/or transmission component 1904, depicted in FIG. 19), such as an RU, may transmit information to update a machine learning model associated with a training iteration of the machine learning model, as described above.

As further shown in FIG. 13, in some aspects, process 1300 may include receiving (e.g., obtaining), for at least one UE, a local loss value based at least in part on the training iteration of the machine learning model within a time window to receive the local loss value for the training iteration, the time window having an ending (block 1320). For example, the network entity (e.g., using communication manager 1908 and/or reception component 1902, depicted in FIG. 19), such as an RU, may receive, for at least one UE, a local loss value based at least in part on the training iteration of the machine learning model within a time window to receive the local loss value for the training iteration, the time window having an ending, as described above.

In some aspects, process 1300 may include determining an aggregated loss value after an earlier of: reception of all local loss values for the training iteration of the machine learning model, or an expiration of a timer (block 1322). For example, the network entity (e.g., using communication manager 1908 and/or determination component 1910, depicted in FIG. 19), such as a CU or a device of a core network, may determine an aggregated loss value after an earlier of: reception of all local loss values for the training iteration of the machine learning model, or an expiration of a timer, as described above.

Process 1300 may include additional aspects, such as any single aspect or any combination of aspects described below and/or in connection with one or more other processes described elsewhere herein.

In a first aspect, the time window is prior to an expiration of a timer for loss aggregation.

In a second aspect, alone or in combination with the first aspect, a start of the timer is at a beginning of transmission of the information to update the machine learning model.

In a third aspect, alone or in combination with one or more of the first and second aspects, process 1300 includes determining, such as by a CU or a device of a core network, an aggregated loss value after an earlier of reception of all local loss values for the training iteration of the machine learning model, or the expiration of the timer.

In a fourth aspect, alone or in combination with one or more of the first through third aspects, process 1300 includes transmitting (e.g., outputting or providing), such as by an RU, a configuration for a timer for one training iteration of the machine learning model.

In a fifth aspect, alone or in combination with one or more of the first through fourth aspects, the time window is an occasion of a periodic resource.

In a sixth aspect, alone or in combination with one or more of the first through fifth aspects, the information to update the machine learning model is transmitted in an occasion of a different periodic resource.

In a seventh aspect, alone or in combination with one or more of the first through sixth aspects, process 1300 includes transmitting (e.g., outputting or providing), such as by an RU, a configuration for a periodic resource pattern that indicates the periodic resource and the different periodic resource.

In an eighth aspect, alone or in combination with one or more of the first through seventh aspects, the time window starts after a time gap from transmission of the information to update the machine learning model.

In a ninth aspect, alone or in combination with one or more of the first through eighth aspects, process 1300 includes transmitting (e.g., outputting or providing), such as by an RU, a configuration for the time gap.

In a tenth aspect, alone or in combination with one or more of the first through ninth aspects, process 1300 includes transmitting (e.g., outputting or providing), such as by an RU, a configuration for a batch size of data to be used for one or more training iterations of the machine learning model.

In an eleventh aspect, alone or in combination with one or more of the first through tenth aspects, process 1300 includes receiving (e.g., obtaining), such as by an RU, prior to a first training iteration of the machine learning model, information indicating a size of local data at the at least one UE.

In a twelfth aspect, alone or in combination with one or more of the first through eleventh aspects, receiving the local loss value includes receiving the local loss value and information indicating a batch size of data to be used for the training iteration together in one transmission.

In a thirteenth aspect, alone or in combination with one or more of the first through twelfth aspects, the information to update the machine learning model includes at least one of one or more gradient values relating to one or more weights for the machine learning model, or the one or more weights for the machine learning model.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with loss reporting for distributed training of a machine learning model.

In some aspects, process 1400 may include receiving a configuration for a batch size for one or more training iterations of a machine learning model (block 1402). For example, the UE (e.g., using communication manager 140 and/or reception component 1602, depicted in FIG. 16) may receive a configuration for a batch size for one or more training iterations of a machine learning model.

In some aspects, process 1400 may include selecting a set of data samples from local data for a training iteration of the machine learning model responsive to the batch size being less than a size of the local data (block 1404). For example, the UE (e.g., using communication manager 140 and/or selection component 1610, depicted in FIG. 16) may select a set of data samples from local data for a training iteration of the machine learning model responsive to the batch size being less than a size of the local data.

As shown in FIG. 14, in some aspects, process 1400 may include receiving information to update the machine learning model associated with the training iteration of the machine learning model (block 1410). For example, the UE (e.g., using communication manager 140 and/or reception component 1602, depicted in FIG. 16) may receive information to update the machine learning model associated with the training iteration of the machine learning model, as described above.

As further shown in FIG. 14, in some aspects, process 1400 may include transmitting a local loss value based at least in part on the training iteration of the machine learning model and information indicating a batch size of data to be used for one or more training iterations of the machine learning model (block 1420). For example, the UE (e.g., using communication manager 140 and/or transmission component 1604, depicted in FIG. 16) may transmit a local loss value based at least in part on the training iteration of the machine learning model and information indicating a batch size of data to be used for one or more training iterations of the machine learning model, as described above.

Process 1400 may include additional aspects, such as any single aspect or any combination of aspects described below and/or in connection with one or more other processes described elsewhere herein.

In a first aspect, process 1400 includes receiving a configuration for the batch size for the one or more training iterations of the machine learning model, and refraining from transmitting the information indicating the batch size based at least in part on receiving the configuration.

In a second aspect, alone or in combination with the first aspect, transmitting the local loss value includes refraining from transmitting the local loss value responsive to the batch size being greater than a size of local data for the training iteration of the machine learning model.

In a third aspect, alone or in combination with one or more of the first and second aspects, process 1400 includes selecting a set of data samples from local data for the training iteration of the machine learning model responsive to the batch size being less than a size of the local data.

In a fourth aspect, alone or in combination with one or more of the first through third aspects, transmitting the information indicating the batch size includes transmitting, prior to a first training iteration of the machine learning model, information indicating a size of local data for training the machine learning model.

In a fifth aspect, alone or in combination with one or more of the first through fourth aspects, the local loss value and the information indicating the batch size are transmitted together for the training iteration.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., base station 110, CU 310, DU 330, RU 340, network entity 705, or the like) performs operations associated with loss reporting for distributed training of a machine learning model.

In some aspects, process 1500 may include transmitting (e.g., outputting or providing) a configuration for a batch size for one or more training iterations of a machine learning model (block 1502). For example, the network entity (e.g., using communication manager 1908 and/or transmission component 1904, depicted in FIG. 19), such as an RU, may transmit a configuration for a batch size for one or more training iterations of a machine learning model.

As shown in FIG. 15, in some aspects, process 1500 may include transmitting (e.g., outputting or providing) information to update the machine learning model associated with a training iteration of the machine learning model (block 1510). For example, the network entity (e.g., using communication manager 1908 and/or transmission component 1904, depicted in FIG. 19), such as an RU, may transmit information to update a machine learning model associated with a training iteration of the machine learning model, as described above.

As further shown in FIG. 15, in some aspects, process 1500 may include receiving (e.g., obtaining), for at least one UE, a local loss value based at least in part on the training iteration of the machine learning model and information indicating a batch size of data to be used for one or more training iterations of the machine learning model (block 1520). For example, the network entity (e.g., using communication manager 1908 and/or reception component 1902, depicted in FIG. 19), such as an RU, may receive, for at least one UE, a local loss value based at least in part on the training iteration of the machine learning model and information indicating a batch size of data to be used for one or more training iterations of the machine learning model, as described above.

Process 1500 may include additional aspects, such as any single aspect or any combination of aspects described below and/or in connection with one or more other processes described elsewhere herein.

In a first aspect, process 1500 includes transmitting (e.g., outputting or providing), such as by an RU, a configuration for the batch size for the one or more training iterations of the machine learning model, where the information indicating the batch size is not received based at least in part on transmitting the configuration.

In a second aspect, alone or in combination with the first aspect, receiving the information indicating the batch size includes receiving, prior to a first training iteration of the machine learning model, information indicating a size of local data at the at least one UE.

In a third aspect, alone or in combination with one or more of the first and second aspects, the local loss value and the information indicating the batch size are received together for the training iteration.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include one or more of a determination component 1608 or a selection component 1610, among other examples.

In some aspects, the apparatus 1600 may be configured to perform one or more operations described herein in connection with FIGS. 7, 8A-8B, 9, 10A-10B, and 11A-11C. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

In some aspects, the reception component 1602 may receive information to update a machine learning model associated with a training iteration of the machine learning model. The transmission component 1604 may transmit a local loss value based at least in part on the training iteration of the machine learning model within a time window to report the local loss value for the training iteration, the time window having an ending. The determination component 1608 may determine the local loss value.

The reception component 1602 may receive a configuration for a timer. The reception component 1602 may receive a configuration for a periodic resource pattern. The reception component 1602 may receive a configuration for a time gap. The reception component 1602 may receive a configuration for a batch size of data to be used for one or more training iterations of the machine learning model.

The selection component 1610 may select a set of data samples from local data for the training iteration of the machine learning model responsive to the batch size being less than a size of the local data.

The transmission component 1604 may transmit, prior to a first training iteration of the machine learning model, information indicating a size of local data for training the machine learning model.

In some aspects, the reception component 1602 may receive information to update a machine learning model associated with a training iteration of the machine learning model. The transmission component 1604 may transmit a local loss value based at least in part on the training iteration of the machine learning model and information indicating a batch size of data to be used for one or more training iterations of the machine learning model. The determination component 1608 may determine the local loss value.

The reception component 1602 may receive a configuration for the batch size for the one or more training iterations of the machine learning model. The selection component 1610 may select a set of data samples from local data for the training iteration of the machine learning model responsive to the batch size being less than a size of the local data.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

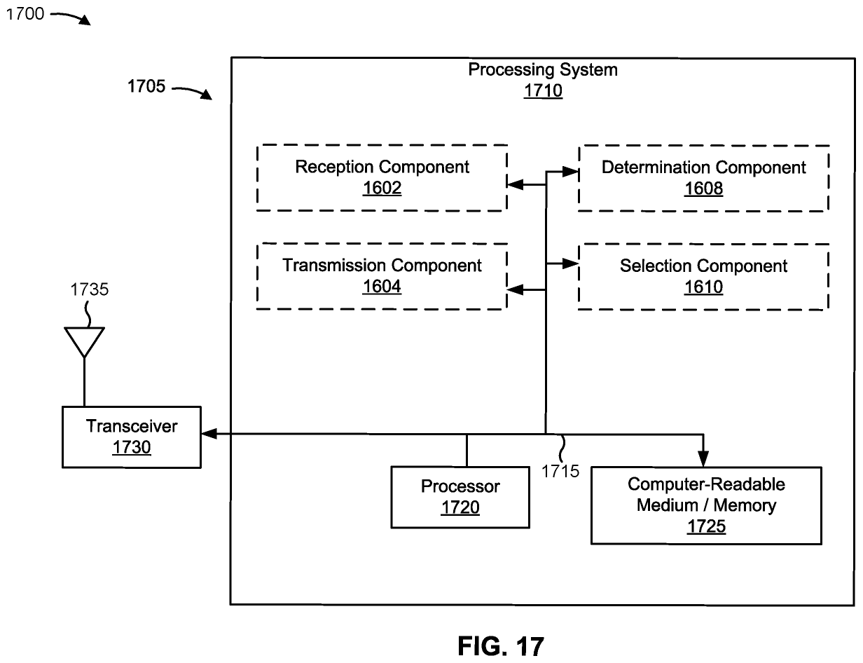

FIG. 17 is a diagram illustrating an example 1700 of a hardware implementation for an apparatus 1705 employing a processing system 1710. The apparatus 1705 may be a UE.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the UE 120 and may include the memory 282 and/or at least one of the TX MIMO processor 266, the RX processor 258, and/or the controller/processor 280. In some aspects, the apparatus 1705 for wireless communication includes means for receiving information to update a machine learning model associated with a training iteration of the machine learning model and/or means for transmitting a local loss value based at least in part on the training iteration of the machine learning model within a time window to report the local loss value for the training iteration, the time window having an ending. Additionally, or alternatively, the apparatus 1705 for wireless communication includes means for receiving information to update a machine learning model associated with a training iteration of the machine learning model and/or means for transmitting a local loss value based at least in part on the training iteration of the machine learning model and information indicating a batch size of data to be used for one or more training iterations of the machine learning model. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 17 is provided as an example. Other examples may differ from what is described in connection with FIG. 17.

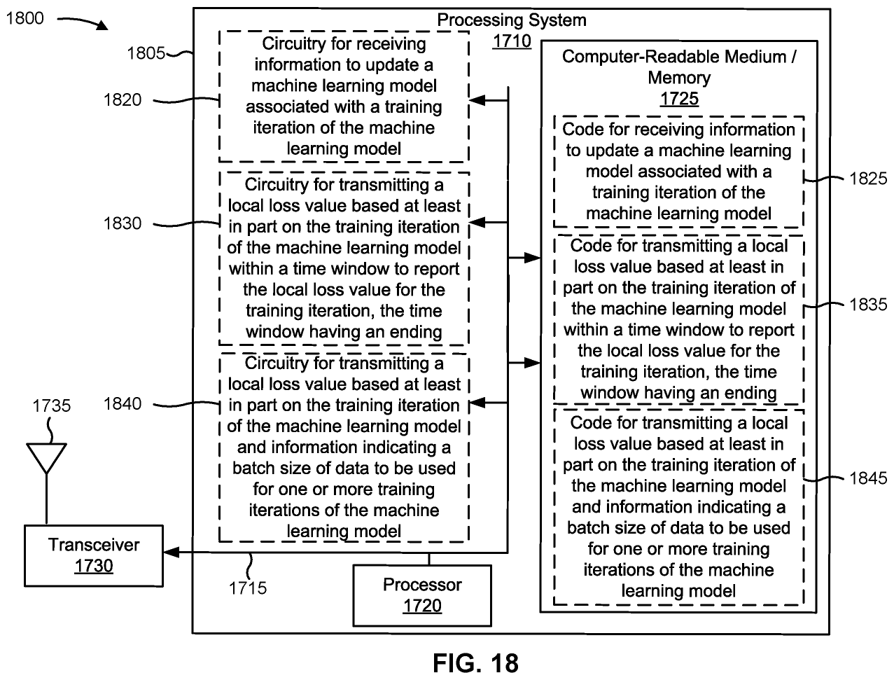

FIG. 18 is a diagram illustrating an example 1800 of an implementation of code and circuitry for an apparatus 1805, in accordance with the present disclosure. The apparatus 1805 may be a UE, or a UE may include the apparatus 1805.

As shown in FIG. 18, the apparatus 1805 may include circuitry for receiving information to update a machine learning model associated with a training iteration of the machine learning model (circuitry 1820). For example, the circuitry 1820 may enable the apparatus 1805 to receive information to update a machine learning model associated with a training iteration of the machine learning model.

As shown in FIG. 18, the apparatus 1805 may include, stored in computer-readable medium 1725, code for receiving information to update a machine learning model associated with a training iteration of the machine learning model (code 1825). For example, the code 1825, when executed by processor 1720, may cause processor 1720 to cause transceiver 1730 to receive information to update a machine learning model associated with a training iteration of the machine learning model.

As shown in FIG. 18, the apparatus 1805 may include circuitry for transmitting a local loss value based at least in part on the training iteration of the machine learning model within a time window to report the local loss value for the training iteration, the time window having an ending (circuitry 1830). For example, the circuitry 1830 may enable the apparatus 1805 to transmit a local loss value based at least in part on the training iteration of the machine learning model within a time window to report the local loss value for the training iteration, the time window having an ending.

As shown in FIG. 18, the apparatus 1805 may include, stored in computer-readable medium 1725, code for transmitting a local loss value based at least in part on the training iteration of the machine learning model within a time window to report the local loss value for the training iteration, the time window having an ending (code 1835). For example, the code 1835, when executed by processor 1720, may cause processor 1720 to cause transceiver 1730 to transmit a local loss value based at least in part on the training iteration of the machine learning model within a time window to report the local loss value for the training iteration, the time window having an ending.

As shown in FIG. 18, the apparatus 1805 may include circuitry for transmitting a local loss value based at least in part on the training iteration of the machine learning model and information indicating a batch size of data to be used for one or more training iterations of the machine learning model (circuitry 1840). For example, the circuitry 1840 may enable the apparatus 1805 to transmit a local loss value based at least in part on the training iteration of the machine learning model and information indicating a batch size of data to be used for one or more training iterations of the machine learning model.

As shown in FIG. 18, the apparatus 1805 may include, stored in computer-readable medium 1725, code for transmitting a local loss value based at least in part on the training iteration of the machine learning model and information indicating a batch size of data to be used for one or more training iterations of the machine learning model (code 1845). For example, the code 1845, when executed by processor 1720, may cause processor 1720 to cause transceiver 1730 to transmit a local loss value based at least in part on the training iteration of the machine learning model and information indicating a batch size of data to be used for one or more training iterations of the machine learning model.

FIG. 18 is provided as an example. Other examples may differ from what is described in connection with FIG. 18.

FIG. 19 is a diagram of an example apparatus 1900 for wireless communication. The apparatus 1900 may be a network entity, or a network entity may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a base station, or another wireless communication device) using the reception component 1902 and the transmission component 1904. As further shown, the apparatus 1900 may include the communication manager 1908. The communication manager 1908 may include, may be included in, or may be similar to, the communication manager 150, described herein. The communication manager 1908 may include a determination component 1910, among other examples.

In some aspects, the apparatus 1900 may be configured to perform one or more operations described herein in connection with FIGS. 7, 8A-8B, 9, 10A-10B, and 11A-11C. Additionally, or alternatively, the apparatus 1900 may be configured to perform one or more processes described herein, such as process 1300 of FIG. 13, process 1500 of FIG. 15, or a combination thereof. In some aspects, the apparatus 1900 and/or one or more components shown in FIG. 19 may include one or more components of the network entity described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive (e.g., obtain) communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network entity described in connection with FIG. 2.

The transmission component 1904 may transmit (e.g., provide or output) communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the network entity described in connection with FIG. 2. In some aspects, the transmission component 1904 may be co-located with the reception component 1902 in a transceiver.

In some aspects, the transmission component 1904 may transmit information to update a machine learning model associated with a training iteration of the machine learning model. The reception component 1902 may receive, for at least one UE, a local loss value based at least in part on the training iteration of the machine learning model within a time window to receive the local loss value for the training iteration, the time window having an ending.

The determination component 1910 may determine an aggregated loss value after an earlier of: reception of all local loss values for the training iteration of the machine learning model, or the expiration of a timer.

The transmission component 1904 may transmit a configuration for a timer for one training iteration of the machine learning model. The transmission component 1904 may transmit a configuration for a periodic resource pattern that indicates the periodic resource and the different periodic resource. The transmission component 1904 may transmit a configuration for the time gap.

The transmission component 1904 may transmit a configuration for a batch size of data to be used for one or more training iterations of the machine learning model.

The reception component 1902 may receive, prior to a first training iteration of the machine learning model, information indicating a size of local data at the at least one UE.

In some aspects, the transmission component 1904 may transmit information to update a machine learning model associated with a training iteration of the machine learning model. The reception component 1902 may receive, for at least one UE, a local loss value based at least in part on the training iteration of the machine learning model and information indicating a batch size of data to be used for one or more training iterations of the machine learning model.

The transmission component 1904 may transmit a configuration for the batch size for the one or more training iterations of the machine learning model.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

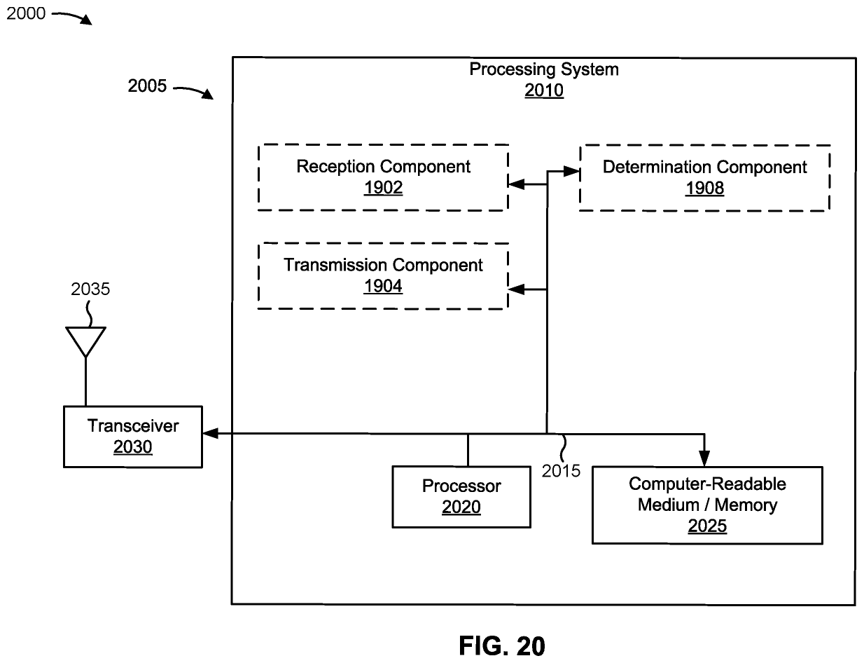

FIG. 20 is a diagram illustrating an example 2000 of a hardware implementation for an apparatus 2005 employing a processing system 2010. The apparatus 2005 may be a network entity.

The processing system 2010 may be implemented with a bus architecture, represented generally by the bus 2015. The bus 2015 may include any number of interconnecting buses and bridges depending on the specific application of the processing system 2010 and the overall design constraints. The bus 2015 links together various circuits including one or more processors and/or hardware components, represented by the processor 2020, the illustrated components, and the computer-readable medium/memory 2025. The bus 2015 may also link various other circuits, such as timing sources, peripherals, voltage regulators, and/or power management circuits.

The processing system 2010 may be coupled to a transceiver 2030. The transceiver 2030 is coupled to one or more antennas 2035. The transceiver 2030 provides a means for communicating with various other apparatuses over a transmission medium. The transceiver 2030 receives a signal from the one or more antennas 2035, extracts information from the received signal, and provides the extracted information to the processing system 2010, specifically the reception component 1902. In addition, the transceiver 2030 receives information from the processing system 2010, specifically the transmission component 1904, and generates a signal to be applied to the one or more antennas 2035 based at least in part on the received information.

The processing system 2010 includes a processor 2020 coupled to a computer-readable medium/memory 2025. The processor 2020 is responsible for general processing, including the execution of software stored on the computer-readable medium/memory 2025. The software, when executed by the processor 2020, causes the processing system 2010 to perform the various functions described herein for any particular apparatus. The computer-readable medium/memory 2025 may also be used for storing data that is manipulated by the processor 2020 when executing software. The processing system further includes at least one of the illustrated components. The components may be software modules running in the processor 2020, resident/stored in the computer readable medium/memory 2025, one or more hardware modules coupled to the processor 2020, or some combination thereof.

In some aspects, the processing system 2010 may be a component of the base station 110 and may include the memory 242 and/or at least one of the TX MIMO processor 230, the RX processor 238, and/or the controller/processor 240. In some aspects, the apparatus 2005 for wireless communication includes means for transmitting information to update a machine learning model associated with a training iteration of the machine learning model and/or means for receiving, for at least one UE, a local loss value based at least in part on the training iteration of the machine learning model within a time window to receive the local loss value for the training iteration, the time window having an ending. Additionally, or alternatively, the apparatus 2005 for wireless communication includes means for transmitting information to update a machine learning model associated with a training iteration of the machine learning model and/or means for receiving, for at least one UE, a local loss value based at least in part on the training iteration of the machine learning model and information indicating a batch size of data to be used for one or more training iterations of the machine learning model. The aforementioned means may be one or more of the aforementioned components of the apparatus 1900 and/or the processing system 2010 of the apparatus 2005 configured to perform the functions recited by the aforementioned means. As described elsewhere herein, the processing system 2010 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 20 is provided as an example. Other examples may differ from what is described in connection with FIG. 20.

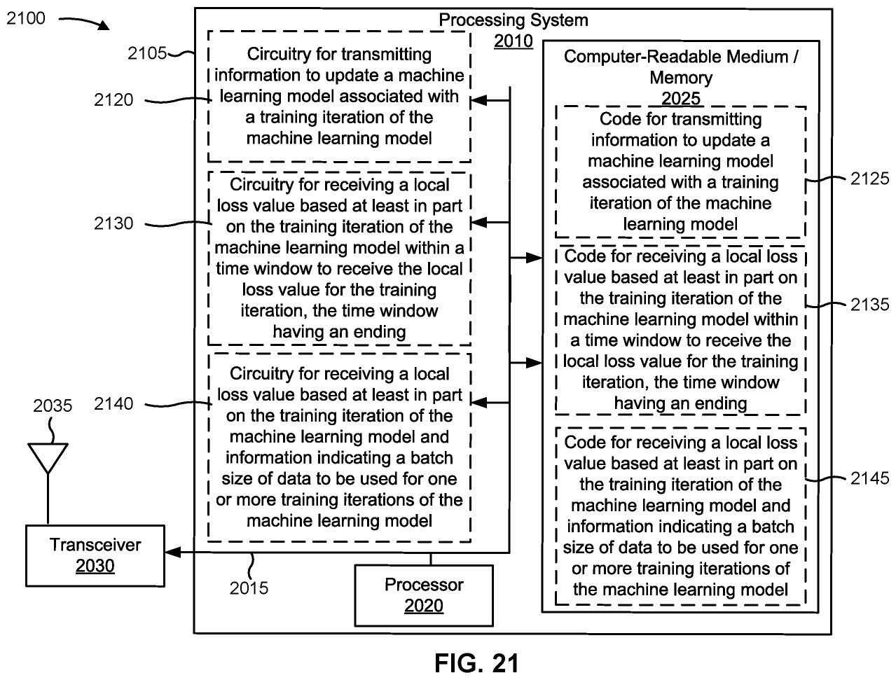

FIG. 21 is a diagram illustrating an example 2100 of an implementation of code and circuitry for an apparatus 2105, in accordance with the present disclosure. The apparatus 2105 may be a network entity, or a network entity may include the apparatus 2105.

As shown in FIG. 21, the apparatus 2105 may include circuitry for transmitting information to update a machine learning model associated with a training iteration of the machine learning model (circuitry 2120). For example, the circuitry 2120 may enable the apparatus 2105 to transmit information to update a machine learning model associated with a training iteration of the machine learning model.

As shown in FIG. 21, the apparatus 2105 may include, stored in computer-readable medium 2025, code for transmitting information to update a machine learning model associated with a training iteration of the machine learning model (code 2125). For example, the code 2125, when executed by processor 2020, may cause processor 2020 to cause transceiver 2030 to transmit information to update a machine learning model associated with a training iteration of the machine learning model.

As shown in FIG. 21, the apparatus 2105 may include circuitry for receiving, for at least one UE, a local loss value based at least in part on the training iteration of the machine learning model within a time window to receive the local loss value for the training iteration, the time window having an ending (circuitry 2130). For example, the circuitry 2130 may enable the apparatus 2105 to receive, for at least one UE, a local loss value based at least in part on the training iteration of the machine learning model within a time window to receive the local loss value for the training iteration, the time window having an ending.

As shown in FIG. 21, the apparatus 2105 may include, stored in computer-readable medium 2025, code for receiving, for at least one UE, a local loss value based at least in part on the training iteration of the machine learning model within a time window to receive the local loss value for the training iteration, the time window having an ending (code 2135). For example, the code 2135, when executed by processor 2020, may cause processor 2020 to cause transceiver 2030 to receive, for at least one UE, a local loss value based at least in part on the training iteration of the machine learning model within a time window to receive the local loss value for the training iteration, the time window having an ending.

As shown in FIG. 21, the apparatus 2105 may include circuitry for receiving, for at least one UE, a local loss value based at least in part on the training iteration of the machine learning model and information indicating a batch size of data to be used for one or more training iterations of the machine learning model (circuitry 2140). For example, the circuitry 2140 may enable the apparatus 2105 to receive, for at least one UE, a local loss value based at least in part on the training iteration of the machine learning model and information indicating a batch size of data to be used for one or more training iterations of the machine learning model.

As shown in FIG. 21, the apparatus 2105 may include, stored in computer-readable medium 2025, code for receiving, for at least one UE, a local loss value based at least in part on the training iteration of the machine learning model and information indicating a batch size of data to be used for one or more training iterations of the machine learning model (code 2145). For example, the code 2145, when executed by processor 2020, may cause processor 2020 to cause transceiver 2030 to receive, for at least one UE, a local loss value based at least in part on the training iteration of the machine learning model and information indicating a batch size of data to be used for one or more training iterations of the machine learning model.

FIG. 21 is provided as an example. Other examples may differ from what is described in connection with FIG. 21.

The following provides an overview of some Aspects of the present disclosure:

Aspect 1: A method of wireless communication performed by a user equipment (UE), comprising: receiving information to update a machine learning model associated with a training iteration of the machine learning model; and transmitting a local loss value based at least in part on the training iteration of the machine learning model within a time window to report the local loss value for the training iteration, the time window having an ending.

Aspect 2: The method of Aspect 1, wherein the time window is prior to an expiration of a timer for one training iteration of the machine learning model.

Aspect 3: The method of Aspect 2, wherein a start of the timer is at a beginning of a period in which the machine learning model is to be updated using the information to update the machine learning model.

Aspect 4: The method of any of Aspects 2-3, further comprising: receiving a configuration for the timer.

Aspect 5: The method of Aspect 1, wherein the time window is an occasion of a periodic resource.

Aspect 6: The method of Aspect 5, wherein the information to update the machine learning model is received in an occasion of a different periodic resource.

Aspect 7: The method of Aspect 6, further comprising: receiving a configuration for a periodic resource pattern that indicates the periodic resource and the different periodic resource.

Aspect 8: The method of Aspect 1, wherein the time window starts after a time gap from an end of reception of the information to update the machine learning model.

Aspect 9: The method of Aspect 8, further comprising: receiving a configuration for the time gap.

Aspect 10: The method of any of Aspects 1-9, further comprising: receiving a configuration for a batch size of data to be used for one or more training iterations of the machine learning model.

Aspect 11: The method of Aspect 10, wherein transmitting the local loss value comprises: refraining from transmitting the local loss value responsive to the batch size being greater than a size of local data for the training iteration of the machine learning model.

Aspect 12: The method of Aspect 10, further comprising: selecting a set of data samples from local data for the training iteration of the machine learning model responsive to the batch size being less than a size of the local data.

Aspect 13: The method of any of Aspects 1-9, further comprising: transmitting, prior to a first training iteration of the machine learning model, information indicating a size of local data for training the machine learning model.

Aspect 14: The method of any of Aspects 1-9, wherein transmitting the local loss value comprises: transmitting the local loss value and information indicating a batch size of data to be used for the training iteration together in one transmission.

Aspect 15: The method of any of Aspects 1-14, wherein transmitting the local loss value comprises: refraining from transmitting the local loss value responsive to the ending of the time window occurring prior to determination of the local loss value.

Aspect 16: The method of any of Aspects 1-15, wherein the information to update the machine learning model includes at least one of: one or more gradient values relating to one or more weights for the machine learning model, or the one or more weights for the machine learning model.

Aspect 17: A method of wireless communication performed by a network entity, comprising: transmitting information to update a machine learning model associated with a training iteration of the machine learning model; and receiving, for at least one UE, a local loss value based at least in part on the training iteration of the machine learning model within a time window to receive the local loss value for the training iteration, the time window having an ending.

Aspect 18: The method of Aspect 17, wherein the time window is prior to an expiration of a timer for loss aggregation.

Aspect 19: The method of Aspect 18, wherein a start of the timer is at a beginning of transmission of the information to update the machine learning model.

Aspect 20: The method of any of Aspects 18-19, further comprising: determining an aggregated loss value after an earlier of: reception of all local loss values for the training iteration of the machine learning model, or the expiration of the timer.

Aspect 21: The method of any of Aspects 18-20, further comprising: transmitting a configuration for a timer for one training iteration of the machine learning model.

Aspect 22: The method of Aspect 17, wherein the time window is an occasion of a periodic resource.

Aspect 23: The method of Aspect 22, wherein the information to update the machine learning model is transmitted in an occasion of a different periodic resource.

Aspect 24: The method of Aspect 23, further comprising: transmitting a configuration for a periodic resource pattern that indicates the periodic resource and the different periodic resource.

Aspect 25: The method of Aspect 17, wherein the time window starts after a time gap from transmission of the information to update the machine learning model.

Aspect 26: The method of Aspect 25, further comprising: transmitting a configuration for the time gap.

Aspect 27: The method of any of Aspects 17-26, further comprising: transmitting a configuration for a batch size of data to be used for one or more training iterations of the machine learning model.

Aspect 28: The method of any of Aspects 17-26, further comprising: receiving, prior to a first training iteration of the machine learning model, information indicating a size of local data at the at least one UE.

Aspect 29: The method of any of Aspects 17-26, wherein receiving the local loss value comprises: receiving the local loss value and information indicating a batch size of data to be used for the training iteration together in one transmission.

Aspect 30: The method of any of Aspects 17-29, wherein the information to update the machine learning model includes at least one of: one or more gradient values relating to one or more weights for the machine learning model, or the one or more weights for the machine learning model.

Aspect 31: A method of wireless communication performed by a user equipment (UE), comprising: receiving information to update a machine learning model associated with a training iteration of the machine learning model; and transmitting a local loss value based at least in part on the training iteration of the machine learning model and information indicating a batch size of data to be used for one or more training iterations of the machine learning model.

Aspect 32: The method of Aspect 31, further comprising: receiving a configuration for the batch size for the one or more training iterations of the machine learning model; and refraining from transmitting the information indicating the batch size based at least in part on receiving the configuration.

Aspect 33: The method of Aspect 32, wherein transmitting the local loss value comprises: refraining from transmitting the local loss value responsive to the batch size being greater than a size of local data for the training iteration of the machine learning model.

Aspect 34: The method of Aspect 32, further comprising: selecting a set of data samples from local data for the training iteration of the machine learning model responsive to the batch size being less than a size of the local data.

Aspect 35: The method of Aspect 31, wherein transmitting the information indicating the batch size comprises: transmitting, prior to a first training iteration of the machine learning model, information indicating a size of local data for training the machine learning model.

Aspect 36: The method of Aspect 31, wherein the local loss value and the information indicating the batch size are transmitted together for the training iteration.

Aspect 37: A method of wireless communication performed by a network entity, comprising: transmitting information to update a machine learning model associated with a training iteration of the machine learning model; and receiving, for at least one UE, a local loss value based at least in part on the training iteration of the machine learning model and information indicating a batch size of data to be used for one or more training iterations of the machine learning model.

Aspect 38: The method of Aspect 37, further comprising: transmitting a configuration for the batch size for the one or more training iterations of the machine learning model, wherein the information indicating the batch size is not received based at least in part on transmitting the configuration.

Aspect 39: The method of Aspect 37, wherein receiving the information indicating the batch size comprises: receiving, prior to a first training iteration of the machine learning model, information indicating a size of local data at the at least one UE.

Aspect 40: The method of Aspect 37, wherein the local loss value and the information indicating the batch size are received together for the training iteration.

Aspect 41: An apparatus for wireless communication at a device, comprising a processor; memory coupled with the processor; and instructions stored in the memory and executable by the processor to cause the apparatus to perform the method of one or more of Aspects 1-16.

Aspect 42: A device for wireless communication, comprising a memory and one or more processors coupled to the memory, the one or more processors configured to perform the method of one or more of Aspects 1-16.

Aspect 43: An apparatus for wireless communication, comprising at least one means for performing the method of one or more of Aspects 1-16.

Aspect 44: A non-transitory computer-readable medium storing code for wireless communication, the code comprising instructions executable by a processor to perform the method of one or more of Aspects 1-16.

Aspect 45: A non-transitory computer-readable medium storing a set of instructions for wireless communication, the set of instructions comprising one or more instructions that, when executed by one or more processors of a device, cause the device to perform the method of one or more of Aspects 1-16.

Aspect 46: An apparatus for wireless communication at a device, comprising a processor; memory coupled with the processor; and instructions stored in the memory and executable by the processor to cause the apparatus to perform the method of one or more of Aspects 17-30.

Aspect 47: A device for wireless communication, comprising a memory and one or more processors coupled to the memory, the one or more processors configured to perform the method of one or more of Aspects 17-30.

Aspect 48: An apparatus for wireless communication, comprising at least one means for performing the method of one or more of Aspects 17-30.

Aspect 49: A non-transitory computer-readable medium storing code for wireless communication, the code comprising instructions executable by a processor to perform the method of one or more of Aspects 17-30.

Aspect 50: A non-transitory computer-readable medium storing a set of instructions for wireless communication, the set of instructions comprising one or more instructions that, when executed by one or more processors of a device, cause the device to perform the method of one or more of Aspects 17-30.

Aspect 51: An apparatus for wireless communication at a device, comprising a processor; memory coupled with the processor; and instructions stored in the memory and executable by the processor to cause the apparatus to perform the method of one or more of Aspects 31-36.

Aspect 52: A device for wireless communication, comprising a memory and one or more processors coupled to the memory, the one or more processors configured to perform the method of one or more of Aspects 31-36.

Aspect 53: An apparatus for wireless communication, comprising at least one means for performing the method of one or more of Aspects 31-36.

Aspect 54: A non-transitory computer-readable medium storing code for wireless communication, the code comprising instructions executable by a processor to perform the method of one or more of Aspects 31-36.

Aspect 55: A non-transitory computer-readable medium storing a set of instructions for wireless communication, the set of instructions comprising one or more instructions that, when executed by one or more processors of a device, cause the device to perform the method of one or more of Aspects 31-36.

Aspect 56: An apparatus for wireless communication at a device, comprising a processor; memory coupled with the processor; and instructions stored in the memory and executable by the processor to cause the apparatus to perform the method of one or more of Aspects 37-40.

Aspect 57: A device for wireless communication, comprising a memory and one or more processors coupled to the memory, the one or more processors configured to perform the method of one or more of Aspects 37-40.

Aspect 58: An apparatus for wireless communication, comprising at least one means for performing the method of one or more of Aspects 37-40.

Aspect 59: A non-transitory computer-readable medium storing code for wireless communication, the code comprising instructions executable by a processor to perform the method of one or more of Aspects 37-40.

Aspect 60: A non-transitory computer-readable medium storing a set of instructions for wireless communication, the set of instructions comprising one or more instructions that, when executed by one or more processors of a device, cause the device to perform the method of one or more of Aspects 37-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, the one or more processors configured to:
receive information to update a machine learning model associated with a training iteration of the machine learning model; and
transmit a local loss value based at least in part on the training iteration of the machine learning model within a time window to report the local loss value for the training iteration, the time window having an ending.

2. The apparatus of claim 1, wherein the time window is prior to an expiration of a timer for one training iteration of the machine learning model.

3. The apparatus of claim 2, wherein a start of the timer is at a beginning of a period in which the machine learning model is to be updated using the information to update the machine learning model.

4. The apparatus of claim 1, wherein the time window is an occasion of a periodic resource.

5. The apparatus of claim 4, wherein the one or more processors, to receive the information to update the machine learning model, are configured to:
receive the information to update the machine learning model in an occasion of a different periodic resource.

6. The apparatus of claim 1, wherein the time window starts after a time gap from an end of reception of the information to update the machine learning model.

7. The apparatus of claim 1, wherein the one or more processors are further configured to:
receive a configuration for a batch size of data to be used for one or more training iterations of the machine learning model.

8. The apparatus of claim 7, wherein the one or more processors, to transmit the local loss value, are configured to:
refrain from transmitting the local loss value responsive to the batch size being greater than a size of local data for the training iteration of the machine learning model.

9. The apparatus of claim 7, wherein the one or more processors are further configured to:
select a set of data samples from local data for the training iteration of the machine learning model responsive to the batch size being less than a size of the local data.

10. The apparatus of claim 1, wherein the one or more processors are further configured to:
transmit, prior to a first training iteration of the machine learning model, information indicating a size of local data for training the machine learning model.

11. The apparatus of claim 1, wherein the one or more processors, to transmit the local loss value, are configured to:
transmit the local loss value and information indicating a batch size of data to be used for the training iteration together in one transmission.

12. The apparatus of claim 1, wherein the one or more processors, to transmit the local loss value, are configured to:
refrain from transmitting the local loss value responsive to the ending of the time window occurring prior to determination of the local loss value.

13. An apparatus for wireless communication at a network entity, comprising:
a memory; and
one or more processors coupled to the memory, the one or more processors configured to:
transmit information to update a machine learning model associated with a training iteration of the machine learning model; and
receive, for at least one UE, a local loss value based at least in part on the training iteration of the machine learning model within a time window to receive the local loss value for the training iteration, the time window having an ending.

14. The apparatus of claim 13, wherein the time window is prior to an expiration of a timer for loss aggregation.

15. The apparatus of claim 14, wherein a start of the timer is at a beginning of transmission of the information to update the machine learning model.

16. The apparatus of claim 14, wherein the one or more processors are further configured to:
determine an aggregated loss value after an earlier of: reception of all local loss values for the training iteration of the machine learning model, or the expiration of the timer.

17. The apparatus of claim 13, wherein the time window is an occasion of a periodic resource.

18. The apparatus of claim 17, wherein the one or more processors, to transmit the information to update the machine learning model, are configured to:
transmit the information to update the machine learning model in an occasion of a different periodic resource.

19. The apparatus of claim 13, wherein the time window starts after a time gap from transmission of the information to update the machine learning model.

20. The apparatus of claim 13, wherein the one or more processors are further configured to:
transmit a configuration for a batch size of data to be used for one or more training iterations of the machine learning model.

21. The apparatus of claim 13, wherein the one or more processors are further configured to:
receive, prior to a first training iteration of the machine learning model, information indicating a size of local data at the at least one UE.

22. The apparatus of claim 13, wherein the one or more processors, to receive the local loss value, are configured to:
receive the local loss value and information indicating a batch size of data to be used for the training iteration together in one transmission.

23. A method of wireless communication performed by a user equipment (UE), comprising:
receiving information to update a machine learning model associated with a training iteration of the machine learning model; and
transmitting a local loss value based at least in part on the training iteration of the machine learning model within a time window to report the local loss value for the training iteration, the time window having an ending.

24. The method of claim 23, wherein the time window is prior to an expiration of a timer for one training iteration of the machine learning model.

25. The method of claim 23, wherein the time window is an occasion of a periodic resource.

26. The method of claim 23, wherein the time window starts after a time gap from an end of reception of the information to update the machine learning model.

27. A method of wireless communication performed by a network entity, comprising:
transmitting information to update a machine learning model associated with a training iteration of the machine learning model; and
receiving, for at least one UE, a local loss value based at least in part on the training iteration of the machine learning model within a time window to receive the local loss value for the training iteration, the time window having an ending.

28. The method of claim 27, wherein the time window is prior to an expiration of a timer for loss aggregation.

29. The method of claim 27, wherein the time window is an occasion of a periodic resource.

30. The method of claim 27, wherein the time window starts after a time gap from transmission of the information to update the machine learning model.
